(19) United States
(12) Patent Application Publication
(10) Pub. No.: US 2012/0075072 A1
(43) Pub. Date: Mar. 29, 2012

(54) CO-LOCATED RADIO-FREQUENCY IDENTIFICATION FIELDS

(76) Inventor: Ravikanth Pappu, Cambridge, MA (US)

(21) Appl. No.: 13/240,173

(22) Filed: Sep. 22, 2011

Related U.S. Application Data
(60) Provisional application No. 61/387,705, filed on Sep. 29, 2010.

(51) Int. Cl. G06K 7/01

(52) U.S. Cl. 340/10.1

(57) ABSTRACT

The present disclosure is directed to methods and systems for co-locating an Radio Frequency Identification (RFID) signal field with a representation perceptible by one or more human senses. A user interface may accessing a representation of a signal field stored in a memory element. The representation may include a plurality of data points each recording a value of a characteristic of the signal field at a respective physical position. Based on the accessed data points, the user interface may provide a human-perceptible representation of the signal field to a user. The human-perceptible representation may facilitate user interactions with the signal field using a RFID device. An interactivity engine may detect an interaction between the RFID device and the signal field. In some embodiments, the interactivity engine may generate an action based on the detected interaction.

### RELATED APPLICATION

This present application claims priority to U.S. Provisional Patent Application Ser. No. 61/387,705, entitled “CO-LOCATED RADIO-FREQUENCY IDENTIFICATION FIELDS”, filed on Sep. 29, 2010, incorporated herein by reference in its entirety for all purposes.

### FIELD OF THE DISCLOSURE

The present disclosure relates generally to radio frequency communications. More specifically, it relates self-powered Radio Frequency Identification (RFID) tiles embedded in objects with configurable functionalities.

### BACKGROUND

Radio technology has long been used to support wireless communications. Based on the evolution of radio technology over the years, it is now possible to communicate via Radio Frequency (RF) in many different ways. For example, according to current RFID technology, it is possible for a so-called RFID tag reader to communicate with multiple RFID tags in a monitored region. According to another technology such as Bluetooth, it is possible for a computer to implement short-range communications with devices such as cell phones, keyboards, etc. According to yet another technology such as WiFi (e.g., 802.11), it is possible to implement a wireless access point in a home network to support medium range communications between the wireless access point and devices such as computers, televisions, etc.

Certain RFID technology enables RFID tag readers to communicate with passive RFID tags. For example, to support communications with the passive RFID tag reader systems, a tag reader's transmitter and receiver must be simultaneously active. In general, this is because the tag reader's transmitted signal is used to power the tag while the tag, in turn, generates a reply back to the tag reader. If the tag reader does not output an RF signal while listening for a tag's response, the tag reader would not be able to receive data from the tag because the tag will power down, making it unable to respond. Thus, for passive tags, the tag reader must output RF energy during the tag's responses to the reader's commands.

Radio technologies such as WiFi, bluetooth, cellular phones, etc., support communications in a different way than do passive RFID tag readers. For example, WiFi, bluetooth, cellular phones, etc., typically support half-duplex communications in which corresponding radio devices must be configured at different times to either transmit data or receive data. Half-duplex communications do not allow two different radio devices to send radio frequency energy bi-directionally to each other at the same time. For example, to implement half-duplex communications, when a first radio device is in the transmit mode, a second radio device must be set to a receive mode to receive data transmitted by the first radio device. Conversely, when the second radio device is in the transmit mode, the first radio device must be set to a receive mode to receive data transmitted by the second radio device. Despite the apparent incompatibility of RFID and other communications protocols, creative implementations incorporating RFID technology with other communications protocols may still be developed.

RFID technology is conventionally used to locate the position or movement of tagged objects. In some embodiments, RFID implementations for detection assume that tagged objects are or will come within range of a RFID reader or detection devices, which may not be easily controlled or ascertained. In some implementations, over-design (e.g., larger density of readers or wider scan zone) can ensure better coverage to enable detection. In some other embodiments, a priori knowledge defines the interaction zone between RFID devices, reducing opportunities for human interaction. Applying RFID technology in unconventional ways may open up new opportunities for interactive applications.

### SUMMARY

In various aspects, the present disclosure describes systems and method for co-locating an RFID field with a field representation perceptible by one or more human senses. RFID signals and fields are invisible and generally undetectable by a typical human unless aided by a detection device. This limitation can preclude certain RFID applications where a person may otherwise assume a more active role in making decisions and/or performing actions with respect to the presence of an RFID field or signal. Allowing a person to perceive an otherwise invisible RFID signal may provide the person an ability, incentive and/or motivation to interact with the RFID signal and/or a respective source of the RFID signal. A human-perceptible representation of a RFID field may be generated and conveyed to a person. Such a representation, co-located with a RFID field, may bring to the person's attention an associated object, person or service. This may influence his decisions as to the associated object, person or service, and induce him to interact with the associated object, person or service via RFID technology.

In one aspect, the present disclosure describes a method for co-locating an Radio Frequency Identification (RFID) signal field with a representation perceptible by one or more human senses. The method may include accessing, by a user interface, a representation of a signal field stored in a memory element. The representation may include a plurality of data points each recording a value of a characteristic of the signal field at a respective physical position. Based on the accessed data points, the user interface may provide a human-perceptible representation of the signal field to a user. The human-perceptible representation may facilitate user interactions with the signal field using a RFID device. An interactivity engine may detect an interaction between the RFID device and the signal field. The interactivity engine may generate an action based on the detected interaction.

In some embodiments, a probe determines the value of a characteristic of the signal field at a respective physical position. The user interface may generate a two-dimensional or three-dimensional representation of the portion of the detected signal field. The user interface may generate a representation perceptible by one or more of: human sight, hearing, touch, smell, taste and sense of temperature. The user interface may generate a representation characterizing the signal field in one or more of the following aspects: field source, signal strength, operating frequency, RFID protocol, temporal movement and operational range.

In certain embodiments, the interactivity engine detects a movement of a portion of the RFID device towards or away from a portion of the signal field based on the human-perceptible representation of the signal field. The interactivity engine may generate a human-perceptible output to the user based on the detected interaction. The interactivity engine may modify the signal field based on the detected interaction. In some embodiments, the interactivity engine communicates a request to modify or update the representation of the signal field stored in the memory element based on the detected interaction. The interactivity engine may communicate with the user interface to modify the human-perceptible representation of the signal field based on the detected interaction. The interactivity engine may distinguish the signal field from one or more other signal fields via the human-perceptible representation.

In one aspect, the present disclosure describes a system for co-locating an Radio Frequency Identification (RFID) signal field with a representation perceptible by one or more human senses. The system may include a memory element storing a representation of a signal field. The representation may include a plurality of data points each recording a value of a characteristic of the signal field at a respective physical position. A user interface, in electrical communication with the memory element, may access the stored representation of the signal field. The user interface may provide a human-perceptible representation of the signal field to a user based on the accessed data points. The human-perceptible representation may facilitate user interactions with the signal field using a RFID device. An interactivity engine may detect an interaction between the RFID device and the signal field, and may generate an action based on the detected interaction.

In some embodiments, the system include a probe for determining a value of a characteristic of the signal field at a respective physical position. The user interface may generate a two-dimensional or three-dimensional representation of the portion of the detected signal field in certain embodiments. The user interface may generate a representation perceptible by one or more of: human sight, hearing, touch, smell, taste and sense of temperature. The user interface may generate a representation characterizing the signal field in one or more of the following aspects: field source, signal strength, operating frequency, RFID protocol, temporal movement and operational range.

In some embodiments, the interactivity engine detects a movement of a portion of the RFID device towards or away from a portion of the signal field. The interactivity engine may generate a human-perceptible output to the user based on the detected interaction. The interactivity engine may modify the signal field based on the detected interaction. The interactivity engine may communicate a request to modify or update the representation.

In yet another aspect, the present disclosure describes embodiments of a RFID tile that can be embedded in various objects and structures, such as furniture, appliances, vehicles, entrances, etc. In certain embodiments, a RFID tile incorporates RFID technology for detecting and monitoring RFID tags, and supports at least one other communications protocol, such as a short-range radio implementation like WiFi. A RFID tile may include an integrated antenna for various communications needs. In some embodiments, a RFID tile may include a plurality of antennas for supporting various communications protocols and/or modules in the RFID tile. A RFID tile may operate according to a performance specification (“hereafter sometimes generally referred to as a “specification”). Since individual product manufacturers can embed the RFID tile in everyday products, a RFID tile may be designed and built to be substantially configurable, and support various performance characteristics and functionality. Furthermore, some embodiments of a RFID tile are designed and constructed to be incorporated aesthetically to host objects, or hidden from view. Since a RFID tile is embedded or attached to host objects, the RFID tile may be self-powered, e.g., via a battery source or solar cells. In certain embodiments, a RFID tile may tap into a power source of a host object.

A RFID tile may leverage on one or more communications protocols for communicating information detected or monitored via its RFID functionality. A RFID tile may, for example, communicate via Bluetooth with a computer that records tag movement across a number of RFID tiles. A RFID tile may also wirelessly communicate with another RFID tile, for example, in a chain fashion, to convey data through a series of RFID tiles to a computer. This avoids having to physically wire one or more RFID devices for communications between RFID devices and/or with the computer. A RFID tile may be configured to communicate with one or more devices, such as HVAC, lighting and/or entertainment systems, to adjust a room's environment to the preference of a user detected by the RFID tile's functionality.

To implement both RFID technology as well as Bluetooth technology, for example, it may be necessary to incorporate separate radio systems such as a first radio system to support RFID radio communications and a second system supporting half-duplex communications such as Bluetooth communications. Many of the components in each RF system may be duplicative. That is, each system, even though configured to communicate in different ways, may include some of the same RF components. Embodiments herein include unique ways to implement radio technology capable of supporting multiple types of radio communications such as a combination of passive RFID tag communications as well as half-duplex radio communications.

More specifically, in one embodiment, a transceiver circuit includes an input to receive an RF mode control signal, multiple ports, and path circuitry disposed between the multiple ports. The path circuitry can be configured to create different conductive paths between the multiple ports depending on a state of the RF mode control signal. As an example, assume that the transceiver circuit includes a first port for coupling the transceiver circuit to an output of a transmitter circuit, a second port for coupling the transceiver circuit to an input of a receiver circuit, and a third port for coupling the transceiver circuit to an RF transducer assembly. Based on selection of a first mode as specified by the RF mode control signal, the path circuitry can be configured to simultaneously provide: i) a conductive path between the transmitter circuit and the RF transducer assembly, and ii) a conductive path between the RF transducer assembly and the receiver circuit. Thus, the transceiver circuit can be configured to support a full-duplex mode in which an RF transducer assembly both transmits RF energy and receives RF energy at the same time.

In one embodiment, when set to the full-duplex mode, the transmitter drives the RF transducer assembly to create a continuous wave RF output signal transmitted into a monitored region to power one or more RFID tags in the monitored region. While also in the full-duplex mode, the RF transducer assembly detects responses by the one or more RFID tags and produces a corresponding electrical signal through the transceiver circuit to the receiver circuit. Accordingly, while the transmitter circuit drives the RF transducer assembly to power the one or more RFID tags, the receiver circuit detects responses by the one or more RFID tags as detected by the RF transducer assembly.

In one embodiment, the RF transducer assembly includes one or more antenna devices for communicating in a monitored region. Note further that the path circuitry and/or transceiver circuit can be configured to support half-duplex communications such as one or more of: Bluetooth™ communications, 802.11 communications, cellular phone communications, etc. For example, when in a second mode as specified by the mode control signal, the path circuitry in the transceiver circuit can be configured to switch between creating a low impedance conductive path between the first port and the third port to enable the transmitter to drive the RF transducer assembly and creating a low impedance conductive path between the second port and the third port to enable the receiver to receive signals produced by the RF transducer assembly. Thus, in accordance with embodiments herein, path circuitry according to embodiments herein can be configured to toggle between sub-modes of: i) providing a conductive path between the transmitter circuit and the RF transducer assembly, and ii) providing a conductive path between the RF transducer assembly and the receiver circuit. The sub-modes can be non-overlapping in time such that the path circuitry does not provide the conductive path between the transmitter circuit and the RF transducer assembly and the conductive path between the RF transducer assembly and the receiver circuit at the same time.

Accordingly, a transceiver circuit according to embodiments herein can enable half-duplex communications as well as full-duplex communications depending on a respective state of input such as an RF mode control signal. As previously discussed, conventional radio systems implement independently operating radio systems including separate transmitters and receivers. In contrast, according to embodiments herein, a same set of transmitter circuits, receiver circuits, and/or other circuits can be shared between different modes to support different types of communications such as full-duplex and half-duplex operational modes via use of switching circuitry that selectively creates paths amongst ports of the transceiver circuit depending on a selected operational mode. Because the circuitry is shared, implementing a transceiver circuit according to embodiments herein can result in overall reduced circuit costs and a reduced circuit footprint over conventional RF techniques.

In one embodiment, the transmitter circuit includes a modulator in communication with a baseband bus circuit. The receiver can include a demodulator in communication with the baseband bus circuit. The baseband bus circuit can be coupled to a first baseband processing module and a second baseband processing module depending on which mode has been selected.

In further embodiments, the first baseband processing module is configured to manage communications associated with RFID tags. The second baseband processing module is configured to manage half-duplex communications with radio devices that support communications such as Bluetooth™ communications, 802.11 communications, cellular phone communications, etc. Depending on an operational mode of the transceiver circuit (e.g., whether it is in the full-duplex mode or half-duplex mode), the baseband bus circuit switches between connecting the transmitter circuit and the receiver circuit to different baseband circuits.

In accordance with yet further embodiments, the transceiver circuit can include an RF isolation circuit configured to reduce coupling of a signal from a first port and a second port of the transceiver circuit. For example, as previously discussed, the transceiver circuit can include a first port coupled to an output of a transmitter circuit, a second port coupled to an input of a receiver circuit, and a third port coupled to an RF transducer assembly. The RF isolation circuit reduces a level coupling between the transmitter circuit and the receiver circuit when the transceiver circuit is in the full-duplex mode.

Thus, one embodiment herein includes adding RFID read capability to an existing radio communications system such as WiFi/Bluetooth/cellular/WiMax. In such an application, RFID tags can be used as containers of pointers to digital data. An embodiment focuses on containing configuration data for wireless access in a WiFi or Bluetooth or GSM/3G context. All wireless networks have security/access credentials that are entered through synchronized button pushing, wired network, flash drives or manual entry.

Note that the concepts herein can include a passive, semi-passive or active RFID tag for receiving configuration information from a wireless device. The tag stores the information in a location such as non-volatile memory. A user or other devices physically moves the tag to a device (e.g., a computer system) to be configured. The device can include an RFID tag reader for reading this information and configuring itself to be immediately connected. As will be discussed later in this specification, one possible application is multi-user network environments such as a coffee shop where upon payment of a good such as coffee, wireless access can be provided to the purchaser on a time-expired basis without requiring a credit card or other means of access.

Techniques herein are well suited for use in applications such as those supporting communications via use of different types of radio technology. However, it should be noted that configurations herein are not limited to such use and thus configurations herein and deviations thereof are well suited for use in other environments as well. Note that each of the different features, techniques, configurations, etc. discussed herein can be executed independently or in combination. Accordingly, the present invention can be embodied and viewed in many different ways.

Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives or permutations of the invention, the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein as illustrated in the accompanying drawings in which like reference characters refer to the same parts throughout the different views. The drawings are not necessarily to scale, with emphasis instead being placed upon illustrating the embodiments, principles and concepts.

FIG. 1 is an example diagram of a transceiver circuit according to embodiments herein;

FIG. 2 is a diagram illustrating an example radio system according to embodiments herein;

FIG. 3 is a diagram illustrating an example radio system according to embodiments herein;

FIG. 4 is a diagram illustrating example use of radio system and switching between modes according to embodiments herein;

FIGS. 5-8 illustrate example methods according to embodiments herein;

FIG. 9 is a block diagram of another isolation circuit according to embodiments herein;

FIG. 10 is a block diagram of another isolation circuit according to embodiments herein;

FIG. 11 is a block diagram of controllable impedance and related circuits according to embodiments herein;

FIG. 12 is a block diagram of controllable impedance and related circuits according to embodiment herein;

FIG. 13 is a flow chart illustrating a method of finding a substantially optimal point on a curve according to embodiments herein;

FIG. 14 is a flow chart of an embodiment of a method of executing an algorithm each time an RFID reader hops to a different frequency;

FIG. 15 is an example diagram illustrating an access point according to embodiments herein;

FIG. 16 is an example diagram illustrating a device configured to include a radio system according to embodiments herein;

FIG. 17 is an example diagram illustrating an access point and related devices according to embodiments herein;

FIG. 18 is a block diagram of one embodiment of a RFID Tile providing Zigbee support;

FIG. 19 is an example of a RFID Tile implementation with RFID monitoring regions above table tops;

FIG. 20 is a block diagram of one embodiment of a RFID Tile providing WiFi support;

FIG. 21 is a block diagram of one embodiment of a RFID Tile providing wireless USB support;

FIG. 22 is a block diagram of one embodiment of an implementation using physical wiring to connect to spatially-distributed antennas positioned for coverage;

FIGS. 23 and 24 are block diagrams of embodiments of a scalable implementation using RFID Tiles with optional wired connections to additional antennas;

FIG. 25 is a flow chart of an embodiment of a method of a RFID tile for incorporating into a host object;

FIG. 26 is a block diagram of one embodiment of a system for co-locating a RFID field with a field representation perceptible by one or more human senses; and

FIG. 27 is a flow chart of one embodiment of a method for co-locating a RFID field with a field representation perceptible by one or more human senses.

### DETAILED DESCRIPTION

Conventional ways of implementing a combination of passive RFID technology and half-duplex technology on the same computer platform suffer from a number of deficiencies. For example, there currently is no solution for communicating with RFID tags and other technology such as WiFi, bluetooth, cellular phones, etc., via an integrated system that provides a combination of these functions. For example, to implement both types of technologies enabling a source such as a computer system to communicate with a number of devices including passive RFID tags, cellular phones, WiFi devices, Bluetooth devices, etc., it would be necessary for a computer user to purchase and install separate RF systems such as a first radio system to support RFID radio communications and a second system supporting half-duplex communications.

Embodiments herein include unique ways to implement radio technology capable of supporting multiple types of radio communications such as a combination of passive RFID tag communications as well as half-duplex radio communications via a unique, integrated RF solution.

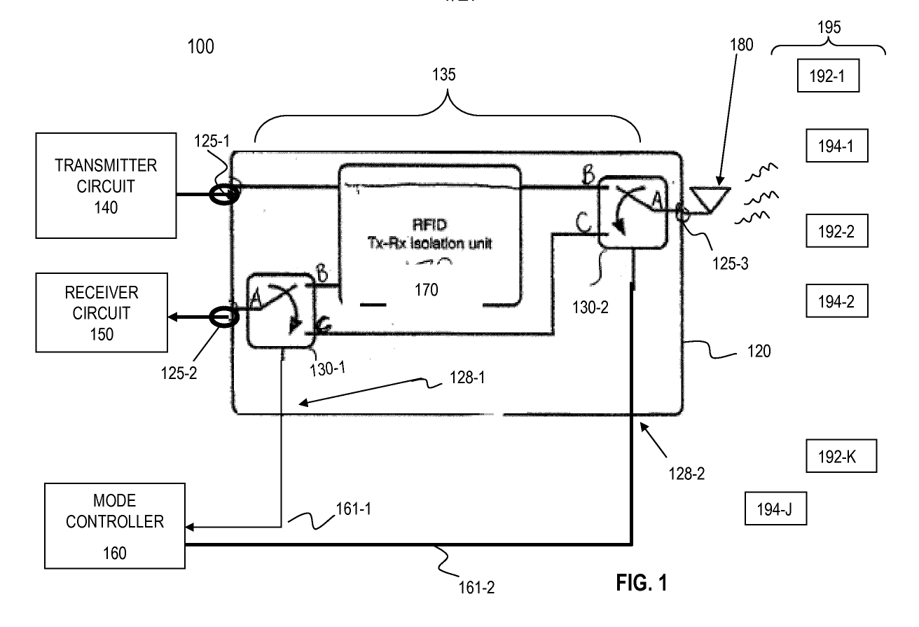

For example, FIG. 1 is an example diagram of a transceiver circuit 120 according to embodiments herein. As shown, transceiver circuit 120 includes one or more input 128 (e.g., input 128-1 and input 128-2) to receive an RF mode control signal 161. In the context of the present example, the RF mode control signal 161 includes signal 161-1 and signal 161-2. Signal 161-1 produced by mode controller 160 controls a state of switch 130-1. Signal 161-2 produced by mode controller 160 controls a state of switch 130-2.

Based on which mode has been selected by mode controller 160, the transceiver circuit 120 can enable different types of communications with target devices such as remote devices 192 (collectively, remote device 192-1, remote device 192-2, . . . , remote device 192-K) and remote devices 194 (collectively, remote device 194-1, remote device 194-2, . . . , remote device 194-J).

By way of a non-limiting example, remote devices 192 can include one or more types of RF devices such as passive RFID tags. Remote devices 194 can include one or more different types of RF devices such as cellular phones, WiFi devices, Bluetooth devices, etc.

As discussed in more detail below, during operation, mode controller 160 selects between multiple different modes for communicating with either remote devices 192 or remote devices 194.

Transceiver circuit 120 also includes multiple ports such as port 125-1, port 125-2, and port 125-3. The path circuitry 135 disposed between ports 125 can be configured to create different low impedance conductive paths between the multiple ports 125 depending on a state of the RF mode control signal 161 as produced by mode controller 160.

As shown in this example, assume that the transceiver circuit 120 includes: port 125-1 for coupling the transceiver circuit 135 to an output of transmitter circuit 140, port 125-2 for coupling the transceiver circuit 120 to an input of receiver circuit 150, and port 125-3 for coupling the transceiver circuit 120 to RF transducer assembly 180.

RF transducer assembly 180 according to embodiments herein includes one or more transducer devices. In one embodiment, the RF transducer assembly 180 is based on MIMO (Multiple In Multiple Out) transducer technology. In such an embodiment, system 100 can include multiple transmitters and multiple receivers instead of just a single transmitter and receiver. The transceiver circuit 120 can connect the multiple transmitters and/or multiple receivers to a set of transducers depending on a selected mode. When in the half-duplex mode, the transceiver circuit 120 can enable multiple 802.x and WiMax communications using multiple transmitters and receivers coupled to multiple transducer elements of RF transducer assembly 180.

In one direction, RF transducer assembly 180 converts one or more received electrical signal into corresponding RF signals for transmission in monitored region 195. The RF transducer assembly 180 converts the received electrical signal into an RF signal for transmission in the monitored region 195. In this instance, the RF signal transmitted by RF transducer assembly 180 may or may not include modulated or encoded data for transmission in monitored region 195.

In the opposite direction, RF transducer assembly 180 detects RF signals present in monitored region 195. In this latter instance, the RF transducer assembly 180 converts the received RF signal into an electrical signal. Note that the received signal may or may not include modulated data.

According to one embodiment, the transmitter circuit 140 in communication system 100 has the ability to generate an electrical signal for driving RF transducer assembly 180. The signal generated by the RF transducer assembly 180 may or may not include encoded data as mentioned above.

For example, at certain times as will be discussed in more detail below, the transmitter circuit 140 drives RF transducer assembly 180 with a signal of modulated data. For example, the transmitter circuit 140 communicates data to remote devices 192 in the monitored region 195.

At other times, the transmitter circuit 140 drives RF transducer assembly 180 with a signal without modulated or encoded data. In this latter instance, the signal generated by the RF transducer assembly 180 is used to drive the RF transducer assembly 180 for purposes of powering remote devices 192 such as passive RFID tags so that they are able to transmit respective wireless responses back to the RF transducer assembly 180 through transceiver circuit 120 to transmitter circuit 150.

The receiver circuit 150 in communication system 100 has the ability to receive electrical signals such as those produced by RF transducer assembly 180 depending on a state of the RF mode control signal 161.

More specifically, note again that the path circuitry 135 is controlled to provide connectivity such as low or high impedance connectivity between transmitter 140 and RF transducer assembly 180 (so that the transmitter circuit 140 can control the output of an RF signal in monitored region 195) as well as low or high impedance connectivity between RF transducer assembly 180 and receiver circuit 150 (so that the receiver circuit 150 can monitor the presence of RF signals by remote devices in monitored region 195).

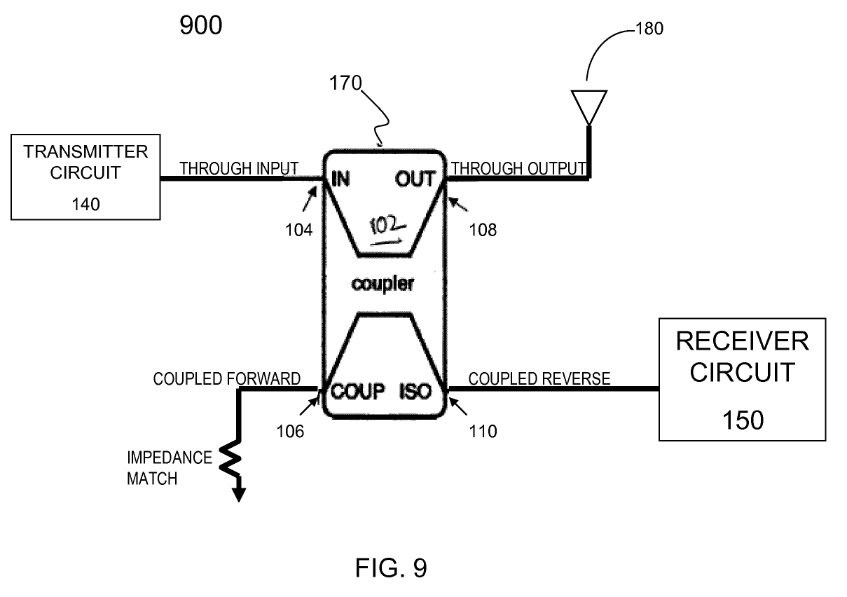

In one embodiment, the transceiver circuit 120 includes an RF isolation circuit 170 as shown. The RF isolation circuit reduces coupling between port 125-1 and port 125-2 of the transceiver circuit 120. For example, as previously discussed, the transceiver circuit can include a port 125-1 coupled to an output of transmitter circuit 140, port 125-2 coupled to an input of receiver circuit 140, and a port 125-3 coupled to RF transducer assembly 180. The RF isolation circuit 170 reduces a level coupling between the transmitter circuit 140 and the receiver circuit 150 when the transceiver circuit 120 is in the full-duplex mode such as when the RF mode control signal 161-1 drives switch 130-1 so that port A and port B are connected and when the RF mode control signal 161-2 drives switch 130-2 so that port A and port B are connected. More details of an example of isolation circuit 170 are shown and discussed with respect to FIGS. 9-14 below.

To select a so-called full-duplex mode, the mode controller 160 produces RF mode control signal 161 to: i) provide a connection such as a low impedance path between port A and port B of switch 130-1, and ii) provide a connection such as a low impedance path between port A and port B of switch 130-2. During such a condition, the switch 130-1 and switch 130-2 provide high impedance paths between respective ports A and ports C. In other words, when in the full-duplex mode, switch 130-1 provides a high impedance path between port A and port C. Switch 130-2 provides a high impedance path between port A and port C.

Based on selection of the first mode (such as a so-called full-duplex mode) as specified by the RF mode control signal 161, the path circuitry 135 in transceiver circuit 120 can be configured to simultaneously provide: i) a first conductive path between the transmitter circuit 140 through RF isolation circuit 170 to the RF transducer assembly 180, and ii) a second conductive path between the RF transducer assembly 180 through the RF isolation circuitry 170 back to the receiver circuit 150.

The first conductive path enables the transmitter circuit 140 to drive the RF transducer assembly 180 and produce an RF signal for transmission in monitored region 195. The second conductive path enables the receiver circuit 150 to receive signals produced by the RF transducer assembly 180. Accordingly, when so configured, the output of transmitter circuit 150 can control generation of RF signals in monitored region 195. The input of receiver circuit 140 can monitor RF signals produced by remote devices 192 in monitored region 195.

Thus, according to embodiments herein, the transceiver circuit 120 can be configured to support a so-called full-duplex mode in which the RF transducer assembly 180 both transmits RF energy in monitored region 195 as well as receives RF energy from 180 at the same time. As previously discussed, transmission of RF energy and detection of RF energy may or may not include transmitting of detecting modulated or encoded data.

Thus, use of the term full-duplex mode in the subject application does not always require that the RF signal transmitted or outputted from RF transducer assembly 180 actually include any encoded data. As previously discussed, the RF signal generated by RF transducer assembly 180 may be transmitted for purposes of powering remote devices 192 such as RFID tags in the monitored region 195.

When set to the full-duplex mode as specified by mode controller 160, the transmitter circuit 140 drives the RF transducer assembly 180 to create a continuous wave RF output signal transmitted in monitored region 195 to power one or more RFID tag in the monitored region 195. While also in the full-duplex mode, as indicated above, the RF transducer assembly 180 detects responses by the one or more RFID tags and produces a corresponding electrical signal through the transceiver circuit 120 to the receiver circuit 150. Accordingly, while the transmitter circuit 140 drives the RF transducer assembly 180 to power the one or more RFID tags such as remote devices 192, the receiver circuit 150 monitors responses by the one or more RFID tags based on the electrical signal received from the RF transducer assembly 180.

Accordingly, communication system 100 can be configured to communicate in accordance with a full-duplex mode to support communication with remote devices such as passive RFID tags.

Note further that the path circuitry 135 and/or transceiver circuit 120 can be configured to support other types of communicates such as half-duplex communications. For example, the half-duplex communications can include one or more of the following types of communications: Bluetooth™ communications, 802.11 communications, cellular phone communications, etc.

To select a half-duplex mode, the mode controller 160 sets a state of RF mode control signal 161-1 to provide a low impedance path between port A and port C of switch 130-1 and a high impedance path between port A and port B of switch 130-1.

The half-duplex mode has two sub-modes as a result of toggling a state of RF mode control signal 161-2 so that switch 130-2 switches between connecting port A to port B (e.g., sub-mode A) and connecting port A to port C (e.g., sub-mode B).

Based on creation of a conductive path between port 125-1 and port 125-3 during sub-mode A of the half-duplex mode, the transmitter circuit 140 is able to drive RF transducer assembly 180 and produce an RF output in monitored region 195. Conversely, based on creation of a conductive path between port 125-2 and port 125-3 during sub-mode B of the half-duplex mode, the receiver circuit 150 is able to monitor RF transducer assembly 180 and detect a presence of RF responses by the remote devices.

More specifically, when in the half-duplex mode as specified by the RF mode control signal 161, the path circuitry 135 in the transceiver circuit 120 is configured to switch between: i) creating a low impedance conductive path between port 125-1 and port 125-3 to enable the transmitter circuit 140 to drive the RF transducer assembly 180 for a first duration and ii) creating a low impedance conductive path between the second port and the third port to enable the receiver circuit 150 to receive signals produced by the RF transducer assembly 180 for a subsequent duration.

Thus, in accordance with embodiments herein, path circuitry 135 can be configured to toggle between half-duplex sub-modes of: i) providing a conductive path between the transmitter circuit 140 and the RF transducer assembly 180, and ii) providing a conductive path between the RF transducer assembly 180 and the receiver circuit 150.

In one embodiment, the sub-modes of the half-duplex mode are non-overlapping in time such that the path circuitry 135 provides a high impedance path between the transmitter circuit 140 and the RF transducer assembly 180 when there is a low impedance path between the RF transducer assembly 180 and the receiver circuit 150. Conversely, the sub-modes of the half-duplex mode are non-overlapping in time such that the path circuitry 135 provides a low impedance path between the transmitter circuit 140 and the RF transducer assembly 180 when there is a high impedance path between the RF transducer assembly 180 and the receiver circuit 150. Enabling communications in a single direction at a time reduces interference between transmit and receive sub-modes. Given that the ratio of transmitter leakage to RFID signal into the receiver can be as high as 75-95 dB, note that the switches used in this system offer a high amount of isolation such as (>75 dB).

In summary, a transceiver circuit 120 according to embodiments herein can enable half-duplex communications as well as full-duplex communications depending on a respective state of input 128 such as an RF mode control signal 160 as produced by a source such as mode controller 160.

As previously discussed, implementation of conventional radio systems requires use of independently operating radio systems to support both a half-duplex modulate and a full-duplex mode as described herein. In such circumstances, the conventional systems do not afford shared use of a transmitter circuit 140 and receiver circuit 150 (as well as other circuitry) as is possible according to novel embodiments herein.

In one embodiment, the transceiver circuit 120 (e.g., a Tx/Rx port matrix or switch) supports two functions, shown in more detail below. The first function is to act like a normal communications device where the transmit and receive ports are not simultaneously active and the second mode is to have the transmitter on in CW mode and the receiver fully active. It may not be favorable to always operate in this mode since the noise figure of the receiver will then be degraded for half-duplex communications.

In the communications mode, port 125-3 has losses relative to the source port 125-1 that must be very small (˜0 dB) so as not to lose precious transmit power. If the losses through the isolation unit 170 are too high, then an alternative topology which favors the transmitter circuit 140 may be used.

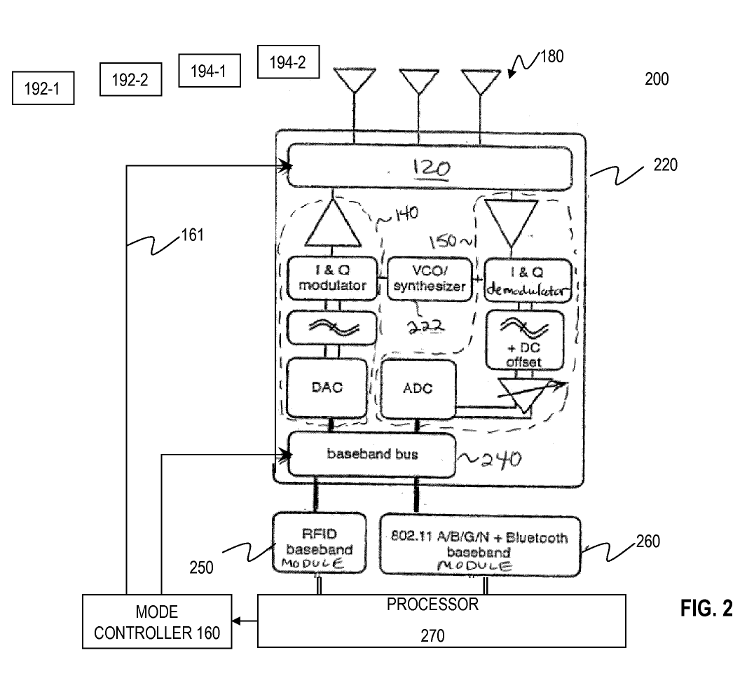

FIG. 2 is an example diagram illustrating communication system 200 including a radio system 220 for communicating with multiple different types of remote devices according to embodiments herein. Radio system 220 can operate at a frequency such as around 2.4 GHz.

As shown, the transmitter circuit 140 includes an amplifier, an I & Q modulator, filter circuitry, and a digital to analog converter circuit. Receiver circuit 150 includes a receiver, an I and Q demodulator, filtering and offset circuitry, and an analog to digital converter circuit. Voltage controlled oscillator 222 controls parameters of both the I and Q modulator and the I and Q demodulator.

Baseband module 250 and baseband module 260 represent any hardware and software functionality to support communications according to embodiments herein. Baseband bus circuit 240 enables either baseband module 250 or baseband module 260 to drive transmitter circuit 150 and receiver circuit 140.

During operation, the baseband bus circuit 240 provides selective connectivity between baseband module 250 and the digital-to-analog converter of transmitter circuit 140 and the analog to digital converter of receiver circuit 150 depending on whether the mode controller 160 selects the full-duplex mode or the half-duplex mode as discussed above. The baseband bus circuit 240 also provides selective connectivity between baseband module 260 and the digital to analog converter of transmitter circuit 140 and the analog to digital converter of receiver circuit 150 depending on whether the mode controller 160 selects the full-duplex mode or the half-duplex mode.

For example, in the full-duplex mode, the baseband bus circuit 240 connects the baseband module 250 to the digital-to-analog converter of transmitter circuit 140 and connects the baseband module 250 to analog to digital converter of receiver circuit 150. In such a mode and as mentioned above, the baseband module 250 can drive transmitter circuit 140 to initiate generation of RF energy in monitored region 195 to communicate with and power remote devices 192 as well as receive responses from remote devices 192 via receiver circuit 150.

For example, in the half-duplex mode, the baseband bus circuit 240 connects the baseband module 260 to digital to analog converter of transmitter circuit 140 and connects the baseband module 250 to analog to digital converter of receiver circuit 150. In such a mode and as mentioned above, the baseband module 260 can drive transmitter circuit 140 to initiate generation of RF energy in monitored region 195 to communicate with and power remote devices 194 as well as receive responses from remote devices 194 via receiver circuit 150. However, because the baseband module 260 supports half-duplex communications, only one of the transmitter circuit 140 and receiver circuit 150 is active at a time supporting communications with remote devices 194.

Thus, depending on an operational mode of the transceiver circuit 120 (e.g., whether it is in the full-duplex mode or half-duplex mode), the baseband bus circuit 240 switches between connecting the transmitter circuit 140 and the receiver circuit 150 to different baseband modules.

With a transmitter CW signal enabled during a tag backscatter response and a direct conversion receiver, a DC offset is always created in the receiver. To maintain proper dynamic range of the system, this DC offset must be removed via some mechanism. Normally, this mechanism is accomplished with a high pass (AC-coupling) or band pass discrete filter network between the RF mixer (IQ modulator (2)) and the IF AGC element (4). When the transceiver is modulating the RF to communicate with a tag, this modulation will produce transients in the receiver that can interfere with the tag response. It is important to make sure the poles and zeros of this IF receive filter (3) are chosen to be appropriate for RFID use. Most other communications systems also have AC-coupling and DC removal circuits for direct conversion receivers, but special consideration will be required to make sure that the time-constants and bandwidth of both types can be accommodated. The ability to switch between two sets of pole-zero filters (one for the traditional communication system, and another for the RFID system) may be required.

For multiple regional operation, strict spectral masks are often required for the transmitter to ensure a minimum amount of interference with legacy applications. In the GSM standard for cellular phones, this is common and requires that the noise produced by the carrier be small enough to accommodate a tight spectral mask. There are at least two types of noise from the transmitter—amplitude (AM) and phase (PM) noise. Usually, AM noise is limited if the digital-to-analog converter (DAC) output is clamped to a particular value, but can be quite large if not. Phase noise is largely a property of the VCO synthesizer. Particular consideration of the type of DAC used and the VCO phase noise will need to be considered in adding RFID to a chip design. One technique employed to improve phase noise is to increase the current into the VCO/synthesizer circuit. Given that the power consumption should not increase for the traditional communications, a switchable current supply may be required to make the tradeoff between phase noise and current consumption.

Finally, the baseband bus (6) may need special consideration. In the event that the radio is capable of communicating both protocols simultaneously, the converter samples may be required to be split or combined depending on the path taken. Furthermore, whether simultaneous or sequential, the converters (ADC and DAC) may operate at different rates. For example, 802.11n can operate at a maximum rate of about 250 mbps, bluetooth 2.1 EDR can operate at 3 mbps, while the Gen2 RFID standard can only operate at 640 kbps.

If the two integrated baseband systems share the same converters (which is not a necessity), then rate converters can operate at the highest possible Nyquist rate. To avoid huge oversampling ratios, the data may be decimated or upconverted to allow for efficient filtering techniques.

In one embodiment, the baseband module 250 is configured to manage communications associated with remote devices 192 such as RFID tags. The baseband module 260 is configured to manage half-duplex communications with radio devices 194 that support communications such as Bluetooth™ communications, 802.11 A/B/G/N communications, cellular phone communications, WiMax, etc.

Processor 270 such as a computer system can be configured to generate mode control signals to select between full-duplex and half-duplex communications, control baseband bus circuit 240, provide data for transmitting in the monitored region 195, process received data, etc. Accordingly, a computer system can be equipped with an RF communication system enabling communications with multiple types remote RF devices.

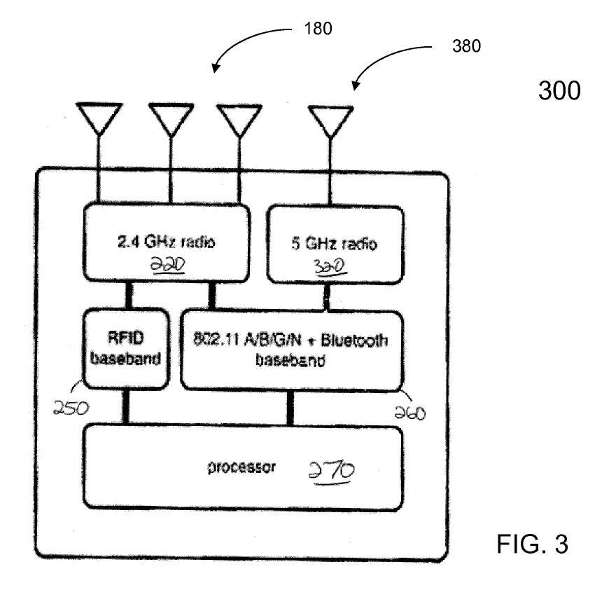

FIG. 3 is an example diagram illustrating communication system 300 according to embodiments herein. As shown, communication system 300 includes radio system 220, baseband module 250, baseband module 260, and processor 270 that operate in manner as previously discussed. Note, however, that communication system 300 can be configured to include an additional radio system 320 for supporting RF communications in a similar manner as discussed above for radio system 220. Radio system 220 can operate around 2.4 GHz. Radio system 320 can operate around 5 GHz. In such an embodiment, radio system 220 supports communications such as bluetooth, 802.11 B/G/N. Radio system 320 supports communications such as 802.11 A/N. Also, in such an embodiment, RF transducer assembly 180 supports 2.4 GHz communications while RF transducer assembly 380 supports 5 GHz communications.

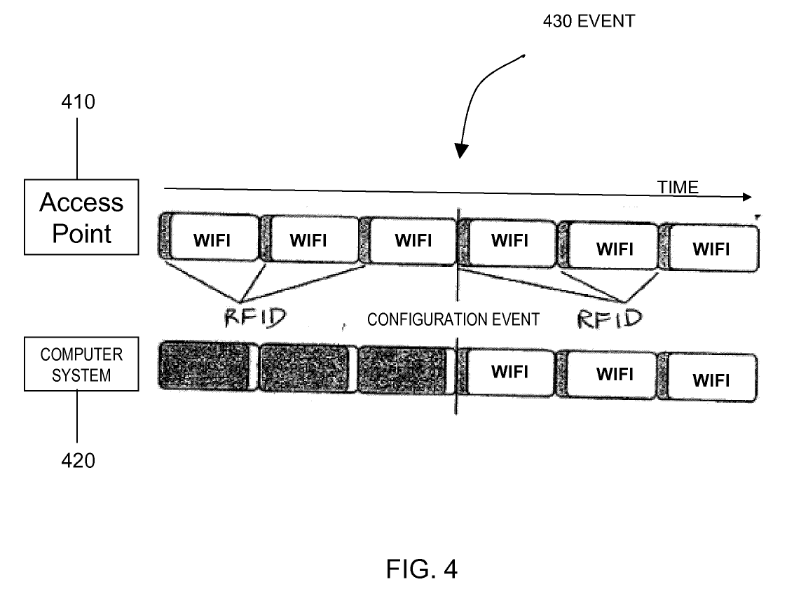

FIG. 4 is an example diagram illustrating scheduling of different communication modes according to embodiments herein. As shown, schedulers associated with computer system 420 and access point 410 can initially allocate different portions of time for monitoring and communicating with RFID tags and communicating with WiFi or bluetooth devices. For example, the access point 410 can allocate a majority of its time in a beacon/discovery mode.

The computer system 420, when first turned on, may not have discovered any remote devices yet so it allocates most of its schedule for monitoring a region for RFID tags and a small portion of time to send beacons in the monitored regions. The RFID tags can indicate how to configure the computer system 420. After the computer system 420 becomes discovered by the access point 410 as indicated by event 430, the computer system 420 can be configured to allocate a greater amount of time to support WiFi, bluetooth, etc., communications rather than RFID tag communications.

More specifically, prior to event 430, the computer system 420 allocates 90% of a schedule to support communications with remote devices 192 such as RFID tags using a full-duplex mode as discussed above. The other 10% of the schedule could be used to support half-duplex communications such as WiFi, bluetooth, cellular phone, etc.

After the event 430, the computer system 420 allocates 10% of a schedule to support communications with remote devices 192 such as RFID tags using a full-duplex mode as discussed above. The other 90% of time would be used to support half-duplex communications such as WiFi, bluetooth, cellular phone, etc.

Of course, the amount of time apportioned to each mode can change depending on current needs of computer system 420.

Also, note that one embodiment herein supports interlacing of communications according to the different communications modes. For example, a communication, transaction, command, etc. may require a number of steps. In certain cases, there is or may be a lag between one step and another. Interlacing of communications can include switching between the full-duplex mode and half-duplex mode to carry out communications in a more efficient manner.

As an example, assume that transaction A includes steps A1, A2, and A3 and will be executed in the half-duplex mode. Assume that transaction B includes steps B1, B2, B3, and B4 and will be executed in the full-duplex mode.

According to embodiments herein, the mode controller can configure the transceiver circuit 120 in the half-duplex mode to enable execution of step A1. After execution of A1, the mode controller 160 can switch the transceiver circuit 120 to the full-duplex mode for execution of steps B1 and B2. Thereafter, the mode controller can switch the transceiver circuit 120 to the half-duplex mode for execution of step A2. Thereafter, the mode controller can switch the transceiver circuit 120 to the full-duplex mode for execution of step B3 and B4. Finally, the mode controller can switch the transceiver circuit 120 back to the full-duplex mode for execution of step A3.

### Sequential Operation of Radios

Since passive RFID tags can misinterpret information from an RF field that is at the same frequency as a reader, it may be useful that a portion of the multi-modal, bi-directional communication system such as 802.11a/b/g/n or Bluetooth not be communicating at the same time as a reader trying to communicate with a tag in monitored region 195. Therefore since frequency diversity is not possible, time diversity is an option for being able to communicate with bi-directional communication radios and RFID tags in a pseudo-simultaneous manner.

The most basic implementation of this system from a conceptual perspective has two distinct radio functionalities combined in a single chip solution. For example, a first radio functionality enables communication with one or more different types of RFID tags (e.g., passive tags, active tags, etc.). A second radio functionality enables traditional communications transceiver such as Bluetooth or 802.11a/b/g/n. A controller can be used to time sequence the operation of the RFID reader so that they are used efficiently and optimally as will described later in the text. In certain modes, the solution as described herein enables interlacing of communications including powering and communicating with passive RFID tags as well as bi-directional communications with other devices using Bluetooth technology, WIFI technology etc.

For systems that would like to add RFID at low incremental cost, that is, with as small a burden in silicon area as possible, an optimization can be made considering the fact that the communications transceiver and RFID transceiver can share functions such as quadrature up- and downconverters and samplers at the same frequency.

### TDMA Operation

The simplest mode of operation is to operate the device in two modes of operation, which have a constant duty cycle between the two radio modes. The parameters of these modes can be configurable. Note further that it is possible to configure radios system 200 to embed further subdivisions of radio modes within part of an operation mode using recursion.

The operational modes can be divided by the operational modes of WiFi or Bluetooth: discovery and operation. In the discovery mode, the proportion of time allocated to an RFID reader should be relatively high to allow rapid recognition of a configuration tag.

An example of this is shown for two devices (e.g., computer system or other device 420 and access point 410) that each have installed a WiFi radio communication system and a shared 2.4 GHz RFID solution as well. The access point 410 connects to a wide area network such as cable, DSL, or fiber in a home.

The computer system 420 or other device communicates wirelessly to the access point 410 in a WLAN. In the discovery phase of this transaction for the computer 420, the access point 410 may be communicating with existing wireless devices, so a beacon frame, typically around 100 ms, supplies the SSID from the access point 410. The access point 410 must spend a small amount of time operating as an RFID radio since it should spend most of it's time doing beacons and communicating data. (There may be opportunities during exponential back-off or during the beacon itself to use this time for RFID as well.)

The situation is different for the computer system 420 as it has two phases: the first phase is the discovery phase where it must look for beacon frames from the access point 410 to know how to connect; and the second phase is the data phase, where it participates in IP communications with the rest of the devices on the WLAN.

In the data mode, or in normal operation, it is not desirable for the reading operation to significantly lower the data rate of the communications protocol, and so, the duty cycle of this mode may be similar to that of the access point 410 in the data plus beacon mode. In the Generation 2 spec from EPC Global, the time to read an RFID tag can take up to 10 ms in normal modes of operation. If this were done with 5% duty cycle for example, relative to the communications protocol, this would allow an attempt to read a tag once every 200 ms, responsive for most types of user interaction.

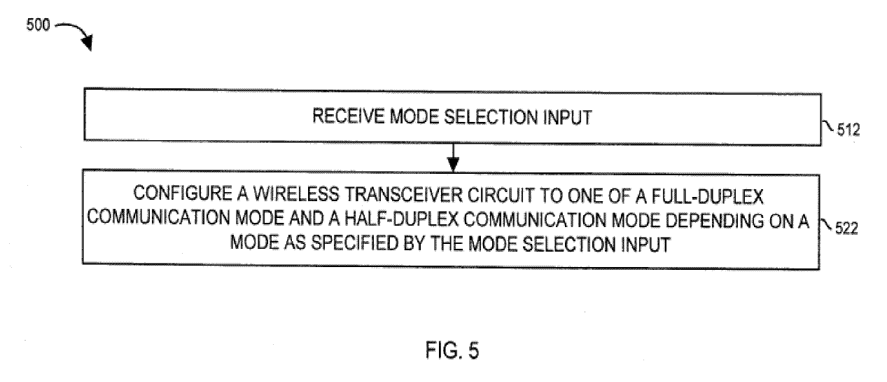

FIG. 5 is a flowchart 500 illustrating a method according to embodiments herein. Note that flowchart 500 of FIG. 5 and corresponding text below will make reference to matter previously discussed with respect to FIGS. 1-4. Note that there will be some overlap with respect to concepts discussed above for FIGS. 1 through 4. Also, note that the steps in the below flowcharts need not always be executed in the order shown. In step 512, the transceiver circuit 120 receives mode selection input from mode controller 160.

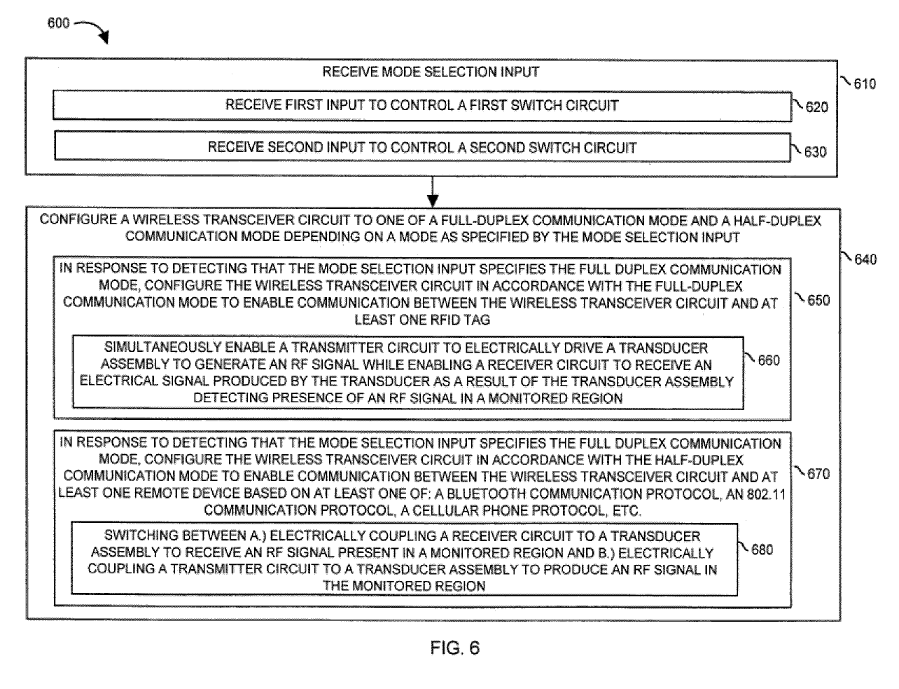

In step 522, the transceiver circuit 120 configures itself to one of a full-duplex communication mode and a half-duplex communication mode depending on a mode as specified by the mode selection input. FIG. 6 is a flowchart 600 illustrating a technique of implementing a transceiver circuit according to embodiments herein. Note that flowchart 600 of FIG. 6 and corresponding text below will make reference to matter previously discussed with respect to FIGS. 1-5.

In step 610, the transceiver circuit 120 receives mode selection input from a source such as mode controller 160.

In sub-step 620, the transceiver circuit 120 receives first input such as RF mode control signal 161-1 to control switch circuit 130-1.

In sub-step 630, the transceiver circuit 120 receives second input such as RF mode control signal 161-2 to control switch circuit 130-2.

In step 640, based on the input, the transceiver circuit 120 configures itself to one of a full-duplex mode and a half-duplex mode depending on a mode as specified by the RF mode control signal 161.

In sub-step 650 of step 640, in response to detecting that the mode selection input specifies the full duplex communication mode, the transceiver circuit 120 configures itself in accordance with the full-duplex communication mode to enable communication between the wireless transceiver circuit and at least one RFID tag such as a remote devices 192 in monitored region 195.

In sub-step 660 of sub-step 650, the transceiver circuit 120 simultaneously enables transmitter circuit 140 to electrically drive RF transducer assembly 180 to generate an RF signal in monitored region 195 while enabling a receiver circuit 150 to receive an electrical signal produced by the RF transducer assembly 180 as a result of the RF transducer assemble 180 detecting presence of an RF signal in a monitored region 195.

In sub-step 670 of step 640, in response to detecting that the mode selection input such as RF mode control signal 161 specifies the full duplex communication mode, the transceiver circuit 120 configures itself in accordance with the half-duplex communication mode to enable communication between the transceiver circuit 120 and at least one remote device 194 based on at least one of: a Bluetooth communication protocol, an 802.11 communication protocol, a WiMax protocol, a cellular phone protocol, etc.

In sub-step 680 of sub-step 670, the transceiver circuit 120 switches between a.) electrically coupling receiver circuit 150 to an RF transducer assembly 180 to receive an RF signal present in a monitored region 195 and b.) electrically coupling transmitter circuit 140 to a RF transducer assembly 180 to produce an RF signal in the monitored region 195.

Accordingly, embodiments herein include switching between a so-called full-duplex mode and a so-called half-duplex mode for communicating with different types of remote devices in a monitored region 195.

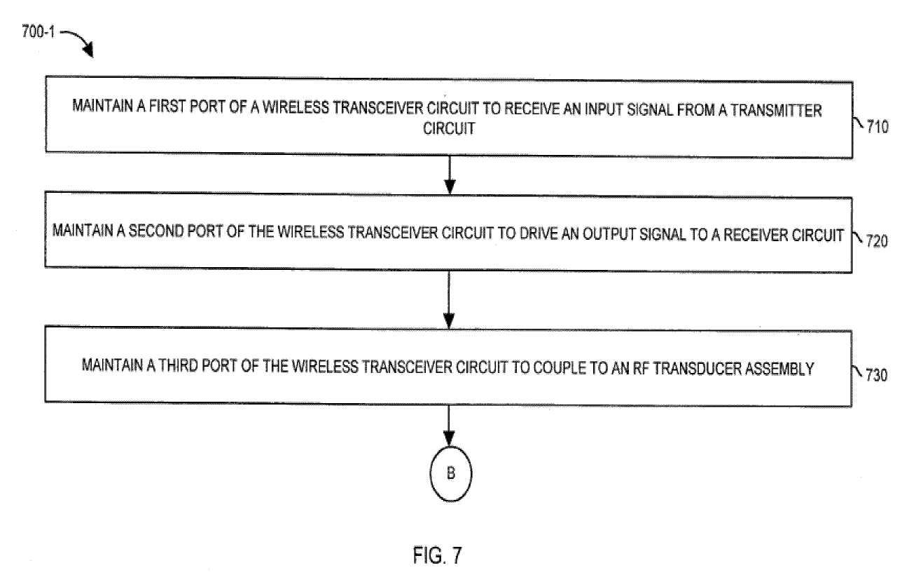

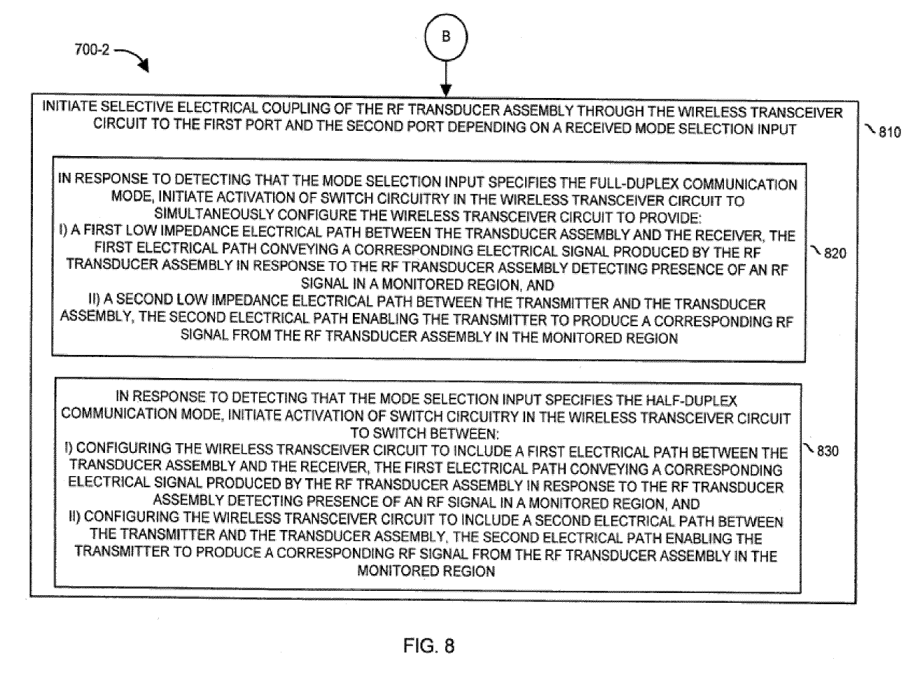

FIGS. 7 and 8 combine to form a flowchart 700 (e.g. flowchart 700-1 and flowchart 700-2) illustrating a technique of implementing a transceiver circuit according to embodiments herein. Note that flowchart 700 and corresponding text below will make reference to matter previously discussed above.

In step 710, the transceiver circuit 120 includes or maintains port 125-1 of transceiver circuit 120 to receive an input signal from transmitter circuit 140.

In step 720, the transceiver circuit 120 includes or maintains port 125-2 of the transceiver circuit 120 to drive an output signal to receiver circuit 150.

In step 730, the transceiver circuit 120 includes or maintains port 125-3 of the transceiver circuit 120 to couple to an RF transducer assembly 180.

In step 810, via path circuitry 135, the transceiver circuit 120 initiates selective electrical coupling of the RF transducer assembly 180 through the transceiver circuit 120 to port 125-1 and port 125-2 depending on received mode selection input as specified by RF mode control signal 161. In sub-step 820 of step 810, in response to detecting that the mode selection input specifies the full-duplex communication mode, the transceiver circuit 120 initiates activation of switch circuitry such as switch circuit 130-1 and switch 130-2 in the transceiver circuit 120 to simultaneously configure the path circuitry 135 of transceiver circuit 120 to include: i) a first electrical path between the RF transducer assembly 180 and the receiver circuit 150, the first electrical path conveying a corresponding electrical signal produced by the RF transducer assembly in response to the RF transducer assembly detecting presence of an RF signal in a monitored region 195, and

ii) a second electrical path between the transmitter circuit 140 and the RF transducer assembly 180, the second electrical path enabling the transmitter to circuit 140 to produce a corresponding RF signal from the RF transducer assembly 180 in the monitored region 195.

In sub-set 830 of step 810, in response to detecting that the mode selection input such as RF mode control signal 161 specifies the half-duplex communication mode, the transceiver circuit 120 initiates activation of switch circuitry such as switch circuit 130-1 and switch circuit 130-2 in the transceiver circuit 120 to switch between: i) configuring the path circuitry 135 of transceiver circuit 120 to include a first electrical path between the RF transducer assembly 180 and the receiver circuit 150, the first electrical path conveying a corresponding electrical signal produced by the RF transducer assembly 180 in response to the RF transducer assembly 180 detecting presence of an RF signal in a monitored region 195, and

ii) configuring the path circuitry 135 of transceiver circuit 120 to include a second electrical path between the transmitter circuit 140 and the RF transducer assembly 180, the second electrical path enabling the transmitter circuit 140 to produce a corresponding RF signal from the RF transducer assembly 180 in the monitored region 195.

FIG. 9 is an example diagram illustrating an isolation circuit 900 according to embodiments herein.

In one embodiment, the isolation circuit 900 is a transmitter-receiver isolation circuit that is based on a single directional coupler 102. A directional coupler couples signals to different output ports depending on the direction of travel of signals through the main path of the directional coupler.

In a specific embodiment, the isolation circuit 900 includes a directional coupler with the coupling among the two output ports relative to the direction of travel of signals along the main path of the directional coupler.

In normal operation, a directional coupler's “through input” port 104 is typically connected to the RFID reader's transmitter such as transmitter circuit 140. The “through output” port 108 is typically connected to an antenna associated with RF transducer assembly 180.

The “coupled forward” port 106 is typically terminated in a matched load resistance, for example a 50-ohm resistor, or a 50-ohm attenuator connected to a forward power sensor that measures transmitter power. The “coupled reverse” port 110 is then connected to the reader's receiver input port such as receiver circuit 150.

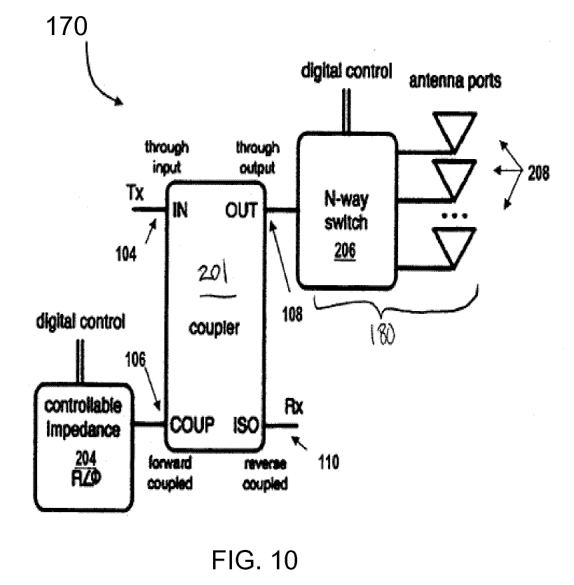

With reference to FIG. 10, another embodiment of an isolation circuit 900 is shown and described. The circuit includes a directional coupler 201, a configurable impedance circuit 204, a switch 206, and one or more antennas 208. The directional coupler 201 communicates with the configurable impedance circuit 204 via the couple forward port 106. The switch 206 communicates with the directional coupler 201 via the through output port 108. The switch also receives input from a processing module to switch among the plurality of antennas 208.

In one embodiment, the directional coupler 201 is a 10 dB directional coupler part number XC0900A-10 manufactured by Anaren Microwave Inc. of East Syracuse, N.Y. In other embodiments other directional couplers having other coupling parameters are used. For example, a circulator or a 6-port coupler and above can also be used

The switch 206 can be an “N-way” switch, where N corresponds to the number of antenna elements 208 in communication with the switch 206. In other embodiments, N is fewer or greater than the number of antenna elements 208 communicating with the switch 206 (e.g., if one of the antenna elements 208 includes an array of elements). In one embodiment, the switch is part number MASW-007813MASW-007813, made by MA/COM of Burlington, Mass.

The antennas 208 associated with RF transducer assembly 180 can be any types of antenna elements. For example, the antenna elements 208 can be, but are not limited to, patch antennas, waveguide slot antennas, dipole antennas, and the like. Each antenna element 208 can be the same type of elements. Alternatively, two or more different types of antenna elements 208 can be used.

In some embodiments, one or more of the antenna elements 208 includes a plurality of antenna elements (i.e., an array of antenna elements). In some embodiments, the antenna elements 208 are multiplexed.

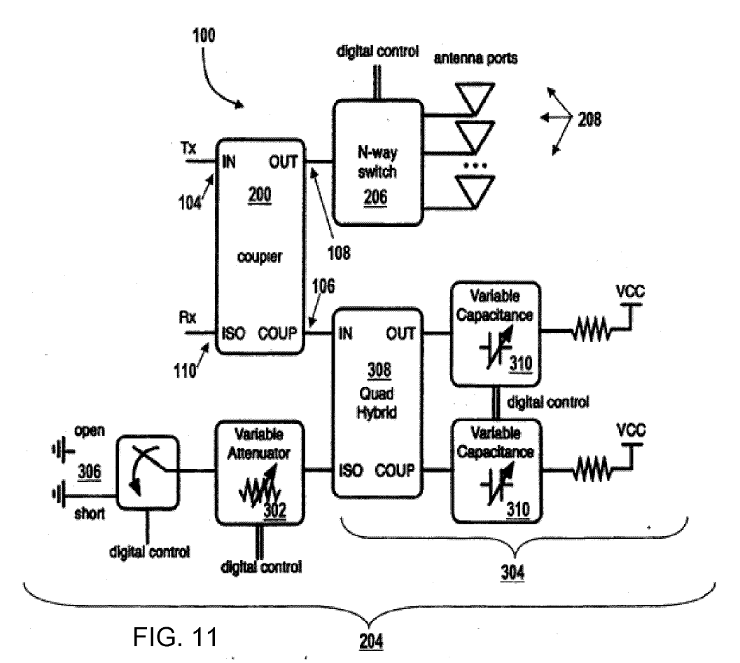

In one embodiment, the controllable impedance circuit 204 includes a variable attenuator, a variable phase shifter, and a reflective load such as an open or short circuit, which are described in more detail below with reference to FIG. 11. In other embodiments, additional or fewer components are included in the controllable impedance circuit 204.

As an operational overview and in one embodiment of operation, the controllable impedance circuit 204 is connected to the forward-coupled port 106 of the directional coupler so that the signal at the reverse-coupled port 110 can be affected by a reflection from the forward-coupled port 106. Thus a sampled portion of the transmitter's signal, varied in magnitude and phase by the controllable impedance circuit 204, can be reflected back into the coupler 201, which then reduces the amount of self-jammer energy present at the reverse-coupled port 110. Since the reader's receiver is connected to the reverse-coupled port 110, the self-jammer energy at the receiver input port can be controlled by adjusting the controllable impedance circuit 204.

With reference to FIG. 11, an embodiment of the controllable impedance circuit 204 is shown and described. The controllable impedance circuit 204 includes a variable attenuator 302, a variable phase shifter 304, and a reflective load 306 such as an open or short circuit.

In one embodiment, the variable attenuator 302 consists of a PIN diode attenuator, a gallium arsenide or silicon monolithic switched resistive attenuator, or any other variable attenuator. In a specific embodiment, the variable attenuator 302 consists of a switched monolithic attenuator part number DAT-15R5-PP available from Mini-Circuits Corp. of Brooklyn, N.Y. In another embodiment the variable attenuator 302 consists of a pair of PIN diodes, part number SMP-1304-011 available from Skyworks Solutions Inc. of Burlington, Mass., connected back-to-back in the a series attenuator configuration.

In operation, the variable attenuator 302 communicates with a digital control device, described in more detail below and receives commands from the digital control device. These commands cause the attenuator 302 to vary between a range of attenuation settings. For example, the attenuator 302 can have a granularity of 0.5 dB and 0 to 15 dB or greater. There is a tradeoff between level of cancellation and step size.

In one embodiment, the variable phase shifter 304 consists of a quadrature hybrid 308 connected to a pair of switched capacitor banks 310 implemented with either discrete components or an integrated circuit. In other embodiments the variable phase shifter 304 consists of a quadrature hybrid 308 connected to a pair of varactor diodes. In one embodiment the phase shifter consists of a quadrature hybrid 308 such as the XC0900P-03S hybrid coupler made by Anaren Microwave Inc. of East Syracuse, N.Y. The 0 degree and 90 degree ports of the hybrid coupler are each connected to a separate array of monolithic capacitors with values 0.5 pF, 1.0 pF, 2.2 pF, and 4.7 pF and switched by a gallium arsenide switch part number MASWSS0064 available from M/A-Com Inc. of Burlington, Mass.

In operation, the variable phase shifter 304 communicates with a digital control device, described in more detail below and receives commands from the digital control device. These commands cause the phase shifter 304 to vary among a variety of phase settings. For example, the phase shifter 304 is capable of approximately 200 degrees of controlled phase shift across the 902-928 MHz band. In another embodiment, the phase shifter 304 consists of 3 series sections and 2 stubs with quarter wavelength between each of the 5 sections.

In one embodiment, reflective load 306 consists of a gallium arsenide semiconductor switch that presents either a short circuit or an open circuit. In one embodiment this switch consists of a gallium arsenide switch part number MASWSS0192 available from M/A-Com Inc. of Burlington, Mass. This switch presents a 180-degree phase shift due to the change in reflectance between the open and short circuit.

When this phase shift is added to the approximately 200 degrees of phase shift available from the previously described phase shifter 304, an aggregate phase shift of greater than 360 degrees is available, which enables the controlled impedance to be placed at any rotation on a Smith Chart, which is also called the plane of complex impedance. In another embodiment, the reflective load 306 includes an open stub with a diode (pin or otherwise) short in front of it for the open short. Also, switched in values of L and C ladders networks can also be used.

In operation, the reflect load 306 communicates with a digital control device, described in more detail below and receives commands from the digital control device. These commands cause the reflective load to vary between the open circuit configuration and the closed circuit configuration.

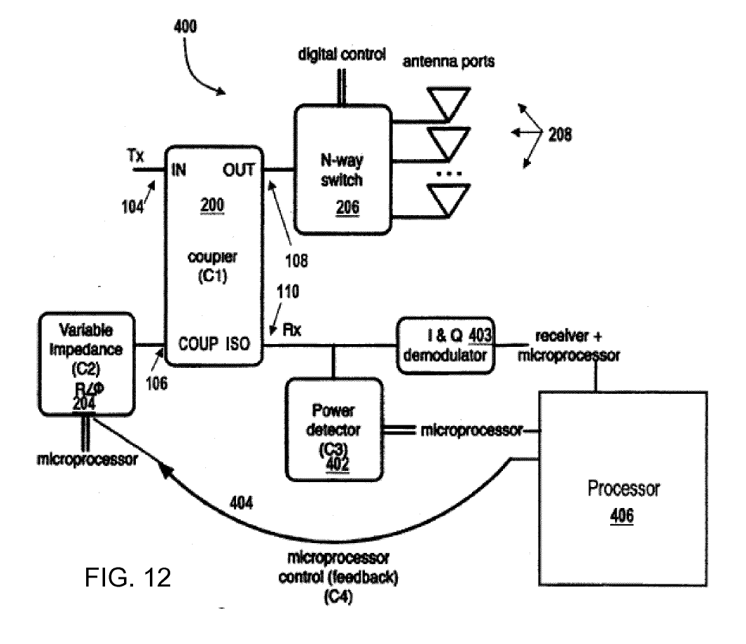

With reference to FIG. 12, one or more aspects of the disclosure are incorporated into the front-end circuitry of an RFID reader 400. The directional coupler 200 is shown as C1. The variable impedance section 304 is shown as C2. An RF power detector 402 at the input of the receiver demodulator 403 is shown as C3. The feedback path 404 C4 is shown wherein the output of the receiver demodulator is sampled and fed to a microprocessor 406 implementing a control method described below in more detail.

In one embodiment, the microprocessor 406 is a DSP. In another embodiment, the microprocessor 406 is a field programmable gate array (FPGA). In another embodiment, one or more application specific integrated circuits (ASIC) are used. Also, various microprocessors can be used in some embodiments. In other embodiments, multiple DSPs are used along or in combination with various numbers of FPGAs. Similarly, multiple FPGAs can be used. In one specific embodiment, the microprocessor 406 is a BLACKFIN DSP processor manufactured by Analog Devices, Inc. of Norwood, Mass. In another embodiment, microprocessor 406 is a TI c5502 processor manufactured by Texas Instruments Inc. of Dallas Tex.

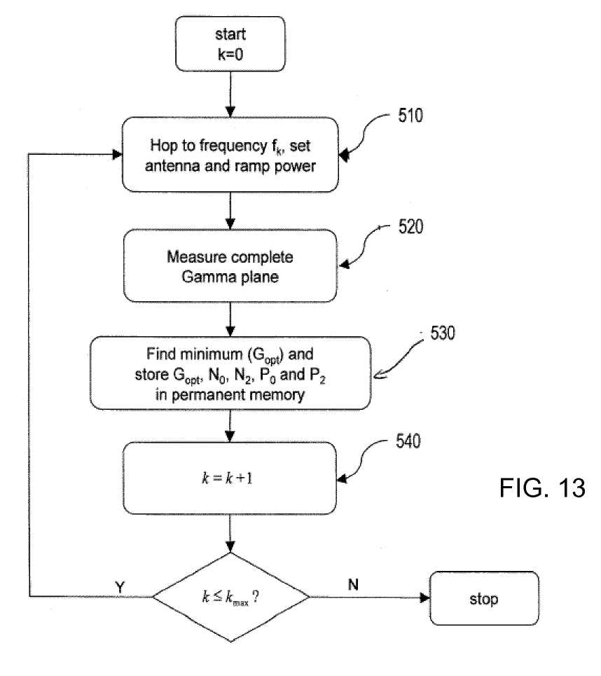

In operation, the feedback from the power detector 402 and demodulator 403 are presented to the microprocessor and used to automatically adjust the controllable circuit 204 to compensate for changes to the self-jammer level as the antenna, operating frequency, or local electromagnetic environment is changed. One method for adjusting the variable impedance is described below with reference to FIG. 13. This method may be implemented in dedicated logic hardware, in a state machine, in a microcontroller, or in software operating on a microprocessor.

With reference to FIG. 12, a method of finding a substantially optimal point on a curve is shown and described. For the parameters shown above, the function curve fit is N(G)=N₀+N₂|Gₒₚₜ−G|², N(G)≦N₀+12 dB, else N(G)=N₀+12 dB, where N is a curve fit function of the baseband noise level that best fits the measured data. In the previous equation, the G-Plane is a representation of the input impedance or load of a system. G=(Z_{L}−R₀)/(Z_{L}+R₀)) where R₀ is the source impedance and Z_{L} is the load impedance.

In operation, the method includes hopping (step 510) to a frequency Fₖ, and then setting the antenna 204 and ramp power. At this setting, the components of the reader cooperate to measure (step 520) the gamma plane. Next, a minimum (i.e., Gₒₚₜ) is found (step 530) and Gₒₚₜ N₀, N₂, P₀ and P₂ are stored in memory, where P is a curve fit function of the power detection that best fits the measured data. The frequency is incremented (step 540) and the measurements are completed and stored again. This continues until the frequency reaches a maximum. In another embodiment, instead of incrementing the frequency it is decremented until it reaches a minimum value. Also, in other embodiments, the frequency is hopped and the order may be pseudo random, incremented/decremented as per local regulations.

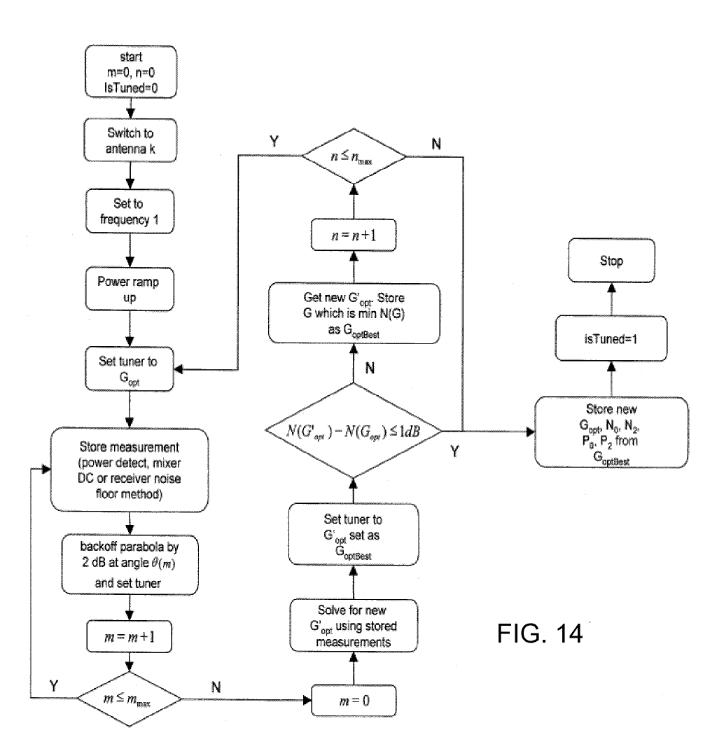

With reference to FIG. 14, an embodiment of a method for executing an algorithm to optimize the setting of the controllable impedance circuit 204 each time the reader hops frequency is shown and described. The m loop provides fine grain setting of tuner Gₒₚₜ. The n loop provides search across wider range when needed. During the m loop, data is collected at four or more points in the vicinity of the current guess of the optimum tune point. This data is expected to be in a parabolic portion of the tuner noise response. This is by virtue of having backed away from the current guess by 2 dB as determined by the current parameters that model the parabolic behavior. After collection of these data, they are used to calculate an updated estimate of for the parabolic behavior, and the minimum G for this new estimate is used as the new Gopt. With four data points, direct calculation may be used to find Gₒₚₜ, N0, and N2. For the case where more than four data points are collected various nonlinear estimation techniques may be used (such as Levenberg-Marquardt, or others). This new estimate is then verified by measurement and if it is within 1 dB of previously determined noise minimums it is assumed to be correct, and the flow chart terminates. If the new Gₒₚₜ estimate is not within 1 dB (parameterized) then it is possible that the optimum tuning has moved far way and the collected data is in the flat portions of the measurement surface. In this case a more global search across a wider range of the tuning range is undertaken and data is measured at Nₘₐₓ new G values.

After data collection of these Nₘₐₓ new values the measured noise values are scanned for minimum and this new minimum is assumed to be the new estimate of the optimum tuning.

Using the circuitry and algorithms described above, there are multiple methods to automatically adjust the configurable impedance circuit 204 to compensate for changes to the self-jammer level. A first method is to examine the receive path noise floor. This is a direct method in the sense that it is a direct measure of one of the effects of the self-jammer noise that the tuner is trying to reduce. The tuning circuitry 204 is passive with respect to the RF signal path, so it does not contribute significant noise on its own, or increase the receiver noise floor. The minimization of the receive path noise floor therefore implies that the controlled impedance is properly adjusted. This noise floor may be measured by digitizing the receiver output with the reader's analog to digital converter(s) and measuring the amount of noise present in a frequency range free of tag responses.

A second method of detecting optimal adjustment of the controlled impedance circuit 204 is by examination of the RF power entering the receive signal path. When there are no interfering signals other than the self-jammer energy, the minimization of total energy present at the receiver input port represents an optimal adjustment of the controlled impedance. It has been observed that the substantial minimization of RF power on the receive path coincides with minimum receive path noise floor. When there are interfering signals present, it is usually the case that the amplitude of the interfering signal is small compared with the self-jammer signal. Thus a minimization of RF power on the receive path still provides an indication of correct adjustment. However, when large interferers are present the detected energy on the receive path provides only weak feedback on the quality of tuning because the self-jammer energy is dominated by the large interfering signal. This is because a wideband RF power measurement at the input of the receiver responds both to the self-jammer as well as any external interferers that may be present.

A third method of controlled impedance circuit 204 optimization is to examine the DC output component of a homodyne receiver's I/Q demodulator. For an ideal I/Q demodulator, when the DC component of both the I and Q demodulator outputs is zero, the tuning is substantially optimum. It has been observed that the minimization or receive noise floor corresponds with near-zero I and Q mixer DC voltage outputs. For a non-ideal demodulator, the controlled impedance circuit 204 adjustment is optimal when the demodulator's output DC component is the same as the inherent DC offset caused by the demodulator itself, for example due to any DC imbalance in the demodulator's internal mixer cells. In one embodiment, a monolithic demodulator, part number LT5575 manufactured by Linear Technology Inc. of Milpitas, Calif., has low inherent offset due to its monolithic construction. This offset and other DC offset sources are in general small compared with the DC values due to the self-jammer energy being measured, and can often be neglected. Alternately the offset may be included as an overall measurement offset. This offset can be stored in a non-volatile memory, for example during a factory calibration, and can be subtracted from measured values obtained during controlled impedance adjustment if this third method of detecting optimal adjustment is employed.

This third method provides two signed numbers (sign+magnitude) to assist in locating the optimal adjustment. The first and second methods provide a single unsigned scalar, the minimum of which constitutes best adjustment. For the previous two methods, direction of adjustment toward an optimum is determined by making small steps in one or more of the controlled impedance circuit 204 parameters (attenuation, phase, and reflection switch) and examining the derivative of the measure. With the third method, the signed numbers, and the fact that there are separate numbers for the demodulator's I mixer and Q mixer outputs provide additional information useful for the controlled impedance adjustment. Also in the vicinity of the optimum tuner setting, the I and Q mixer responses are approximately orthogonal (i.e. movement in the correct direction only affects I, and movement in the perpendicular direction only effects Q). Mixer tuning can be achieved by simply following the correct direction for first one mixer to adjust its output to zero and then adjust in a perpendicular direction to adjust the other output also to zero. This doesn't require more complex nonlinear optimizations of the previous block diagram, and can be achieved by simply following two gradients to zero. Alternatively, as with FIG. 5 and FIG. 6, the tuner may be adjusted across all settings to find setting that brings the I mixer and Q mixer outputs to zero, thus achieving the tuned condition.

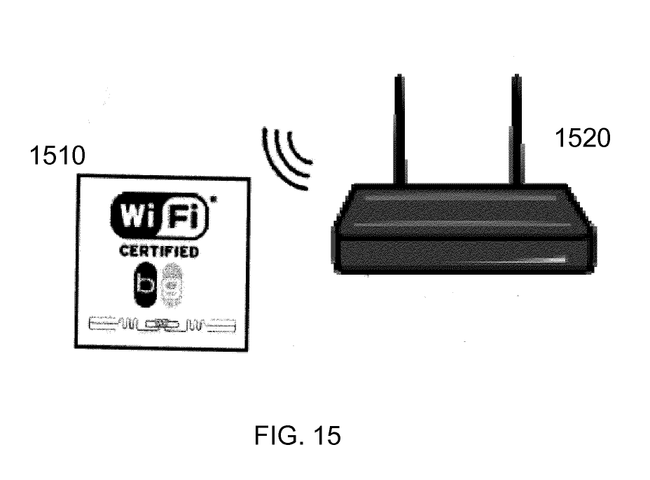

FIG. 15 is an example diagram including a wireless RFID tag and an access point according to embodiments herein.

One embodiment herein includes an integrated circuit that includes a WiFi radio and an RFID radio that operates at one or more frequencies such as 2.4 GHz, 900 Mhz, etc. The integrated circuit can be a wireless system on a chip (SOC). The integrated circuit can be configured to read tags, which are operable (e.g., resonant) at 2.4 GHz or a combination of 900 MHz and 2.4 GHz, etc.

One objective herein is to allow a number of household items to join a wireless network system that have been installed in a home. Currently, WiFi is difficult to implement in laptops for non-experts with WiFi SSIDs, security type, security keys, DHCP/manual addressing setup, etc. The situation is going to be much more difficult for new devices that will appear in homes due to UI issues: Big screen televisions, HD DVD players, game consoles, Skype/VOIP phones, cameras, printers don't have keyboards or mice.

One solution, outlined here, is to use a tag to transfer digital setup information physically for zero-configuration networking where all networking and security information is provided in the tag. If information has been previously entered incorrectly, the information in a tag can override a user's laptop to ensure immediate and proper operation. The sequence for operation in a household example is as follows:

By bringing an un-initialized tag near a WiFi access point (AP) 1520, the combination WiFi/RFID chip in the access point can be used to load configuration information in a tag in a time such as less than 100 ms.

In one embodiment, all of the security and network configuration information can be transferred into a physical token. The tag 1510 could be supplied with the AP (factory programmed) or purchased separately in a tag pack. Another option is that a store service has a trained technical assistant who creates a personalized tag for a particular customer that can be used in their home only.

All configuration for the customer's home network could be obtained at time of purchase. In all cases, this RFID function leverages from the existing RFID industry where a tag costs less than $0.010, making the incremental cost in tag very low. One way to produce a low-cost SOC (e.g., system network chip including WIFI and RFID tag reader) is outlined later in this document.

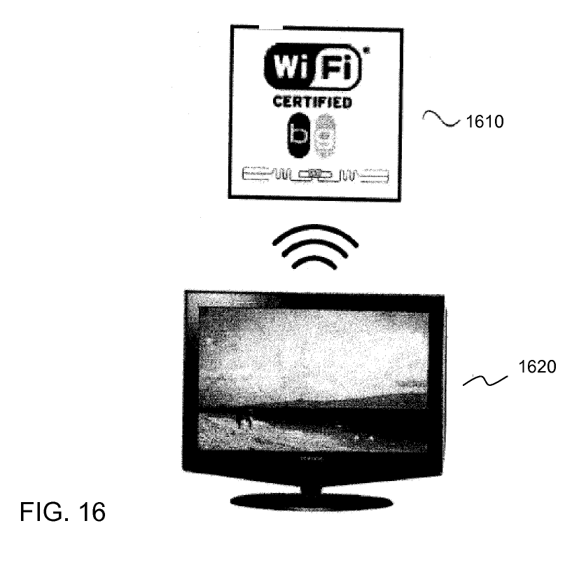

FIG. 16 is an example diagram illustrating a tag 1610 in proximity to a device 1620 according to embodiments herein. By bringing the (configured) tag 1610 near a wireless device 1620 (e.g., a computer system) which has the same or similar wireless SOC including an RFID tag reader, the device 1620 will read the contents of the tag, and transfer those contents to the WiFi radio subsystem and the operating system to configure and notify the system of the changes.

Accordingly, the device 1620 reading the tag 1610 can be configured automatically based on the information retrieved from the tag 1610.

There are possible variants of what subsystem informs the other and in what order those events occur. The wireless SOC could manage all setup information in both networking and security itself and inform the operating system afterwards or could forward information to the operating system which could then decide how it was going to pass information back to the wireless SOC.

The system shown in this example is a television, where a cumbersome process of entering information on a wireless remote control (often without alpha entry) presents a user interface problem that is easily solved with a physical token from the RFID system. This technique can be used in other applications as well.

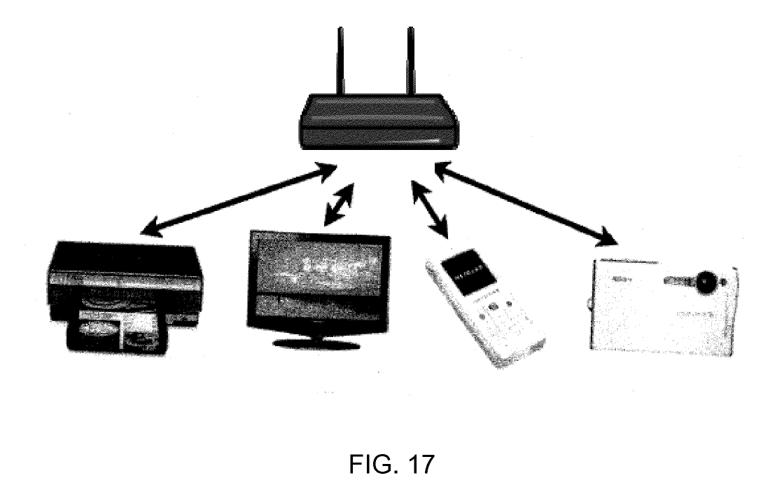

FIG. 17 is an example diagram illustrating an access point and a number of devices in a monitored region according to embodiments herein.

One benefit of this approach is that the incremental work for each device that has this wireless SOC is the same as the first one, without requiring the user to learn the UI of every device and re-key the same information. The UI of these devices can vary depending on form factor and cost profile of the device. The device that is generally the easiest to configure is a computer in notebook or desktop form due to an extensive HW/SW UI associated with most computer notebooks and desktops. Most portable and many desktop computers contain WiFi and Bluetooth radios included in their design and could obviously be added to this “one step” configuration using this wireless SOC containing RFID.

The new Bluetooth standard 2.1+EDR is combining NFC (13.56 MHz technology) with Bluetooth to accomplish a very similar purpose. In this Bluetooth case, at 13.56 MHz tag is used to store the address and passkey information of a particular Bluetooth device. In the cellular GSM/3G context, a network password could be provided, or authentication certificates for downloading content, payment information could be provided. One extension of embodiments herein can include a tag that is semi-passive or active. This may be useful if there was going to be a button on the tag that required human touch, a sound output device (buzzer), display or for novel applications such as a wallet/key finder.

A method of configuration can be very important in many user scenarios, especially when people nearby an owner of the tag should not have access to information in the tag. An example is a coffee shop where one would like to be able to provision a number of laptops or WiFi-enabled cell phones without creating an open network or sharing private information. When a user purchases a coffee at a register, they could get their receipt on an RFID tag that could be used to obtain Internet access by reading contents of the tag to access the Internet. Access can have an associated expiration time or be used as a loyalty program or simply to allow consumers to buy digital access with cash, debit or credit.

If the information is not of the type that can be used to reconfigure the radio, the information is forwarded to the controller for interpretation. One form of interpreting this information could be to treat it as a URL, which contains a pointer to an arbitrary piece of information in an online or local program. Some other examples including use of URLs

1. DVD media. An online service such as Netflix could send a user a cover album of a HD disc which would simply contain a tag which has a URL to an online store, maintaining their current business model (using time through a postal service to regulate flow of bits as opposed to pay per use). Alternatively, a printer company could sell tagged paper which could be encoded with the URL and then the media cover art could be printed on the paper for later use. The paper could be more expensive than normal, containing a “media tax” to be sent to the content/copyright owner.

2. CD media. An online service such as iTunes could allow users to print out cover albums for music they purchased. A user could simply bring this cover art near an entertainment center to play their media and take it away when they are done.

3. Photo Albums. A user could print out a photo that represents a group of photographs. By bringing the photograph near their media center, the photo album would be displayed from local or online content. If more than one photo token was placed near the media center, then the album that would be played would be the concatenation of the multiple ‘photos’.

4. IP phone calling. A user could print out photos of their friends and family. Rather than trying to use a remote to type in a number into a television or entertainment center, the user could bring the photo near their device and immediately initiate a phone or video call.

TinyURL for RFID tags can be stored in the tags such as one or more of remote devices 192. A URL can contain, in principle, an infinite amount of information (they are of unbounded Unicode length). On the other hand, the number of things an infinite number of URLs can point to is finite and is much less than the number of bits contained in an RFID tag (96 bits-3 kbits today for a UHFGen2 tag). Therefore, a look-up service can be used, which will take any URL and make a 64-bit hash (16 billion-billion unique entries)+a 32-bit IP address.

A method for allowing a human to indicate an interest is required. i.e. if these tokens are lying around in your house, you may want someone to be able to indicate which one they want with some kind of switch on the tag. A membrane switch or capacitive load, which requires input such as human contact to work properly, are examples.

Note again that techniques herein are well suited for enabling multiple communication modes using at least a portion of shared circuitry. However, it should be noted that embodiments herein are not limited to use in such applications and that the techniques discussed herein are well suited for other applications as well.

### RFID Tiles

Having discussed various embodiments of systems and techniques of supporting multiple communication modes using at least a portion of shared circuitry, further embodiments of an RFID tile will be discussed. A RFID tile may provide one or more features of a RFID reader, and may be designed and/or configured to be a standalone device. The RFID tile may be configured to be substantially self-sufficient and/or autonomous. One exemplary embodiment of a RFID tile includes a power source, a compact RFID module (e.g., RFID reader), an antenna, a short-range radio system, an API and a RFID performance specification. The short-range radio system may include a transmitter, a receiver, a processor and/or a memory element.

A RFID tile may be designed and constructed for incorporation into a host object. A RFID tile may be embedded in or attached to various objects and structures, such as furniture, appliances, vehicles, building structures and construction components, etc. A RFID tile may be incorporated into a host object by a user, a service provider, or by a manufacturer of the host object, e.g., furniture. A manufacturer may acquire or manufacture RFID tile modules for incorporation into their products. A service provider may acquire RFID tile modules for retrofitting or incorporation into objects such as existing products, vehicles, structures or buildings. In some embodiments, a manufacturer may incorporate a RFID tile as a feature to add value to their product. As the use of RFID tiles proliferates, gains popularity or gains wide acceptance, manufacturers may be motivated to incorporate RFID tiles into their products as a beneficial or standard feature. In certain embodiments, a RFID tile may be designed and built to be compact, unobtrusive or inconspicuous, e.g., characterized by a low profile, substantially rectangular in shape, etc, for flexibility and ease in embedding or attaching to a host object. The color scheme, exterior texture, ruggedness and/or structure of an RFID tile may be selected to be consistent with the design, style and/or utility of the host object and/or its environment. Furthermore, some embodiments of a RFID tile are designed and constructed to be incorporated aesthetically to host objects.

A portion of a RFID tile may be designed or built to be customizable for manufacturers incorporating RFID tiles into their products. For example, a casing or decorative faceplate of the RFID tile may be adapted, repainted, customized, reshaped, machined and/or replaced to match the design, style, color, texture and/or structure of the host object. In yet other embodiments, an RFID tile may be designed and built (e.g., compactly or unobtrusively) to be easily hidden from view when incorporated to a host object. For example, the RFID tile may have a flat, narrow or compact profile for fitting within spaces or gaps in an appliance, furniture or other object. In some embodiments, a RFID tile may be shaped to fit into corners, holes or depressions of a host object. Some RFID tiles may include portions for conforming to the shape or contours of a host object. For example, such portions may be malleable or flexible, or may be fabricated according to functional, spatial or aesthetic needs or constraints. A RFID tile may be designed to blend in with other components of a host object or the design scheme of a host object. In certain embodiments, a RFID tile may replace a component (e.g., a decorative panel) of a host object. The RFID tile may include or support any type of attachment or fastening means for incorporation to a host object, such as adhesive, surface-tension structures, suction devices, screws, bolts, connectors, pins, magnets, etc. In certain embodiments, a RFID tile may be shaped or structured to latch onto or fit into a host object without additional fastening means.

Since some of the host objects may not include a power source, such as in the case of most furniture, the RFID tile may instead be self-powered. In some embodiments, a RFID tile may includes means for generating power or performing energy conversion to power itself. For example, a RFID tile may include one or more batteries as a power source. The RFID tile may include means, e.g., a removable cover, for removing or replacing batteries. A RFID tile's battery may be rechargeable. The battery type may be selected to be compact and/or of low profile in conforming to the structure and design of the RFID tile. In certain embodiments, the battery is selected to be substantially long-lasting, to support operating needs and to extend battery replacement/recharging intervals. The RFID tile may also be designed for low power in operation, such as to sustain battery life. In certain embodiments, a RFID tile may incorporate a solar cell and/or any other type of power source. A RFID tile may incorporate one or more power sources, for example, using a battery as a primary or back-up power source.

In some embodiments, the casing or other portion of the RFID tile may incorporate or comprise a component of the power source. By way of illustration, some portion of the casing may be constructed with a solar cell, battery or an inductive coupling device (e.g., for receiving radiation energy). Such portion of the casing may be machined, molded, fabricated or otherwise manufactured to have a specific shape, structure, profile, texture, pattern, color or look. In certain embodiments, such a portion of the casing may contribute protective cover for certain components of the RFID tile. Such portion of the casing may, in some embodiments, comprise containment or fastening means to keep certain components of the RFID tile together. Such portion of the casing may, in some embodiments, comprise fastening means to attach the RFID tile to a host object.

In certain embodiments, where available, a RFID tile may tap into a power source of a host object, e.g., an electrical appliance or a vehicle. The RFID tile may include an interface or connector, such as a USB connector, for connecting to a power source. A RFID tile using a rechargeable battery may tap into a power source for recharging the battery and/or powering the RFID tile while recharging. For example, a RFID tile may be configured to tap into a host object's power source when its batteries are low in power. A user may manually recharge the RFID tile by connecting it to a power source. A user may remove the RFID tile and/or a battery of the tile for recharging. In some embodiments, a RFID tile may include a power-harvesting device to interface with a power source. For example, a solar cell may receive energy from a light source for conversion into electrical energy. In certain embodiments, an inductive coupler may receive electromagnetic power from a base station, and may further convert the electromagnetic power for storage and/or consumption.

In certain embodiments, a RFID tile incorporates RFID technology for detecting and monitoring RFID tags, and supports at least one other communications protocol. This may include a short-range radio communications protocol, for example. Communications protocols supported may include any one or more of the WLAN WiFi technologies (e.g., 802.11a/b/g/n), WPAN (e.g., Bluetooth, Zigbee, UWB, WiMedia, Wibree, Wireless USB, 61oWPAN, ONE-NET, etc), Cellular (e.g., CDMA/CDMA2000, GSM/UMTS, UMTS over W-CDMA, UMTS-TDD, etc), WIMAN (e.g., WiMax), and other WAN technologies (e.g., iBurst, Flash-OFDM, EV-DO, HSPA, RTT, EDGE, GPRS), though not limited to these. A RFID tile may, for example, communicate via Bluetooth with a computer that records tag movement across a number of RFID tiles. A RFID tile may also wirelessly communicate with another RFID tile, for example, in chain fashion within their individual antenna/communication ranges, to convey data through a series of RFID tiles to a destination computer, router or other device. Deploying a plurality of RFID tiles in such a configuration avoids the need to physically wire one or more RFID devices for communications between RFID devices and/or with the computer, router or other device. In certain embodiments, the RFID tile may be able to leverage on another communication protocol, e.g., WiFi protocol with some changes, to communicate with RFID tags.

A RFID tile may be configured to communicate with one or more devices, via a transmitter and/or a receiver of the RFID tile. For example, the RFID tile may transmit communications to an HVAC, lighting and/or entertainment system, to adjust a room's environment according to the preference of a user detected by the RFID tile. The user may, for example, have a personal item (e.g., cell phone, wallet or key) embedded with a RFID tag that identifies the user and sends this information to the receiver of the RFID tile. The RFID tile may interact with a host object or another system based on this information. The RFID tile may convey the information received from the RFID tag, or may generate a request or command based on the information received, directed to the host object or another system. Based on the received communication from the RFID tile, the host object or other system may operate in a particular manner. For example and in some embodiments, an airport or manufacturing facility may configure RFID tiles to detect personnel movement and/or presence of potentially dangerous objects so as to wirelessly communicate this to security systems and/or central monitoring stations.

In some embodiments, two or more RFID tiles may communication with each other to update a configuration of one of the RFID tiles. By way of illustration, one RFID tile may detect one or more RFID tags supporting different communications protocols and may transmit a request or command to another RFID tile to support one of the detected communications protocols. The latter RFID tile may, for example, download information (e.g., wirelessly from a computer) to configure itself for supporting a desired communication protocol. Additional use-cases for RFID tiles will be described later.

The RFID tile may power itself, e.g., via batteries, for its various communications needs. A RFID tile may include an integrated antenna for its various communications needs. Such an antenna may include any embodiment of antenna features 180, 380, 208 described above, for example in connection with FIGS. 1-3 and 9-12. In some embodiments, a RFID tile may include a plurality of antennas for supporting various communications protocols and/or modules in the RFID tile. The RFID tile may include a rugged antenna for supporting a wide range of environmental and operating conditions to which the RFID tile may be deployed. In certain embodiments, the antenna may enclose a portion of the RFID tile. The antenna may provide protective covering to a portion of the RFID tile. The antenna may be exposed as a portion of the RFID tile. In some embodiments, the antenna may include and/or provide an aesthetic design to an exterior portion of the RFID tile. For example, a portion of the antenna may be machined, molded, fabricated or otherwise manufactured to have a specific shape, structure, profile, texture, pattern, color or look. In certain embodiments, a portion of the antenna may comprise containment or fastening means to hold certain components of the RFID tile together. Such portion of the antenna may, in some embodiments, comprise fastening means to attach the RFID tile to a host object.

An antenna for the RFID tile may include any type or form of antenna adapted for RFID purposes, for example, printed antenna patterns. The RFID tile may include an antenna, for example, of a type referred to as linear polarization, circular polarization, monostatic circular or bistatic circular. The antenna may incorporate a linear, loop or plate structure, although not limited to these structures. The antenna may incorporate features from antennas typically in use to support various communications protocols and applications. For example and in one embodiment, the RFID tile may include an integrated antenna for its RFID functions as well as for Zigbee (or other) communications. The integrated antenna may adapt features from typical Zigbee antenna implementations as well as RFID antennas. In some embodiments, a RFID tile uses an integrated antenna that is a hybrid antenna or a combination antenna.

Since the RFID tile can be embedded in everyday products, as well as custom products, by individual product manufacturers, users or retrofitters, a RFID tile may be designed and built to be suitably configurable. The RFID tile may be configured to support various performance characteristics and functionality. In some embodiments, by making the RFID tile configurable and enabling its wide deployment in bulk, we may expect lower cost implementation in various applications and across applications. By making a RFID tile generic initially, for programming according to specific applications and deployment needs, the RFID tile can offer much flexibility to logistics and management systems. Users can creatively or adaptively configure available RFID tiles to wirelessly communicate information about detected RFID tags with much flexibility. The RFID tiles can be configured to independently or collaboratively communicate information about detected RFID tags to a computer, router or other device.

A RFID tile may operate according to a performance specification or configuration (hereafter sometimes generally referred to as “specification” or “configuration”). A RFID tile's specification may include programming for the RFID tile to communicate via one or more supported communication protocols. The programming may specify to the RFID tile to perform an operation, such as to transmit a communication via a transmitter of the RFID tile, responsive to or based on a certain event or condition. Each specification may specify one or more interactions with the RFID tile's host object, or with another RFID tile or system. For example, the specification may direct the RFID tile to report collected data via bluetooth to a specific computer or device. The specification may direct the RFID tile to store data collected over a defined period of time. The specification may direct the RFID tile to report collected data at certain times or time intervals, or upon certain events.

The specification may direct the RFID tile to communicate collected data to its host object, another system or RFID tile, e.g., so that the second RFID tile can convey the data to a target device. The specification may indicate a battery life for the RFID tile, such as 1 week, 2 weeks, 1 month, etc. The specification may indicate a battery life for the RFID tile, e.g., so that the RFID tag may indicate to a user via sound, light and/or otherwise, that a recharge or replacement battery is due. The specification may indicate a battery life for the RFID tile based on the programmed frequency of transmission, etc. The specification may provide for the use of an indicator, using sound, light, a user interface or otherwise, to convey to a user a state of, or information about, the RFID tile and/or a monitored region. By way of illustration, an indicator may alert a user of a malfunction in the RFID tile, that the RFID tile was not able to communicate with another system, or that collected information is available on the RFID tile.

In certain embodiments, the specification may identify categories of RFID tags (e.g., those embedded in clothing, devices, associated with a particular person, etc) to monitor. The specification may indicate the range and/or locality of monitoring, for example, all tags within three feet from a host object or RFID tile. The specification may identify specific RFID modes of operation to engage in under various circumstances. The specification may indicate whether RFID operation should be interrupted by and/or interleaved with bluetooth or other functionality of the RFID tile. The specification may indicate whether another functionality of the RFID tile may be interrupted by a scheduled RFID operation.

The specification of a respective RFID tile may indicate whether the RFID tile should operate in master mode (e.g., collecting information from a slave RFID tile, or sending instructions to a slave RFID tile) or slave mode (e.g., sending information to a master RFID tile, or receiving instructions from a master RFID tile). The specification of a respective RFID tile may indicate if, how and when the RFID tile can switch between various modes. The specification of a respective RFID tile may provide a schedule for operating the reader of the RFID tile. In certain embodiments, the specification of a respective RFID tile may specify one or more of: a frequency, protocol and power level to operate on, and at particular time periods. The specification of a respective RFID tile may specify an upper limit for the transmission power, e.g., to conform to safety or interference limits. In some embodiments, a RFID tile may be designed to operate at a power level within the permissible exposure limits prescribed by FCC or some other agency.

In some embodiments, the specification may be updated or replaced wirelessly via one or more of the RFID tile's supported communications protocols. The specification may be updated or replaced by physically connecting the RFID tile (e.g., via a cable, or directly via an interface) to a computer or other device. The RFID tile may include an API for communicating specification changes, wirelessly or via wired means, with another device. The API of a RFID tile may, in some embodiments, be used for communicating RFID-related data and/or control signals with another device or RFID tile. For example, upon detection of an individual or an item tagged with an RFID tag, the specification may require that the RFID tag relay associated information to a computer system, or send a command to another system. By way of illustration, the RFID tag may send a command or request to a HVAC system to adjust the temperature of the environment, to a lighting system for adjusting the lighting, to a sound system to initiate, adjust or halt a playback, to a security or tracking system to monitor the individual or item, and/or to initiate any operation responsive to the detection of the individual or item. As such, based on the specification of an RFID tile, the RFID tile may initiate any type of operation responsive or customized to information collected from a RFID tag.

An RFID tile may include a memory element for storing or maintaining one or more specifications. Each of the specification may be specific to a context of the host object. For example, a user may configure or select the specification of the RFID tile based on the corresponding host object. In some embodiments, a RFID tile may detect the type of host object that it is attached to, and may select, reconfigure or download a specification to be consistent with the context of the host object. A RFID tile may also detect the presence of one or more other RFID tiles or devices, and may select, reconfigure or download a specification to interoperate or communicate with them. The memory element may be of any memory type, and in some embodiments can be any one of the following types of memory: SRAM; BSRAM; or EDRAM. Other embodiments include memory elements of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); or any other type of memory.

In certain embodiments, a RFID tile can include a processor or a central processing unit that can access the memory element via: a system bus; a memory port, or any other connection, bus or port that allows the processor to access the memory element. The processor may include any features of the processor 270, 406 described above in connection with FIGS. 2, 3 and 12. The processor may retrieve or select an appropriate specification from the memory element, for example, based on the context of the host object. In some embodiments, the processor reconfigures or reprograms an existing specification, or downloads a new specification, based on the host object. The processor may store the new or reconfigured specification in the memory element. The processor may retrieve the stored specification responsive to receiving a RFID communication from a RFID tag. Based on the received communication and/or the specification, the processor may generate a communication for transmission to another RFID tile or system. The processor may instruct the transmitter to send the communication, in accordance with the specification.

The RFID tile may incorporate features or functionalities of other RFID devices. However, a RFID tile differs in many respects to existing types of RFID devices. One existing type of RFID device is an embedded RFID module, for example, the Mercury 5e RFID reader from THINGMAGIC, INC. Embedded RFID devices are implemented in the form of a circuit card or board, for installation in computers, printers and other devices. Embedded RFID devices communicate tag information directly to their hosts and depend on their host for power. Embedded RFID devices are also built with specific interfaces for installation to a host and cannot be flexibly deployed to a wide range of locations, fixtures and objects. Another existing type of RFID device is a fixed RFID device, such as the Mercury5 reader from THINGMAGIC, INC. A fixed RFID device is typically deployed in a fixed location near high tag traffic. A fixed RFID device requires connection to a power supply and is typically a bulky device that precludes flexible deployment and aesthetic/unobtrusive incorporation to a host object.

By operating as a modular, autonomous and configurable device, a RFID tile can be flexibly deployed and programmed to support one or more applications, e.g., logistics, commercial, residential, institutional and personalized applications. The RFID tile system simplifies installation by avoiding the need to physically connect a RFID device to a power source or to a computer system, thereby avoiding the hassle of planning and installing long runs of coaxial cable to each RFID device or component. In some embodiments, the RFID tile system may also make certain physical interfaces, e.g., required for connecting to a power source and/or for external wiring, redundant. The use of self-contained, compact RFID tiles also allows for mobile applications to be supported. By deploying a distributed “tile” system, spatially-distributed RFID tiles can wirelessly communicate and interoperate with each other to extend the range of RFID monitoring and detection, while communicating data back to other devices such as a data collection and monitoring computer. Therefore, the modular approach of the RFID tile can allow a corresponding application platform to be scalable in size, range and complexity.

By way of example and not intended to be limiting in any way, the following are embodiments of platforms suitable for incorporating RFID tiles. RFID tiles may be deployed in hospitals, doctors' offices, care facilities, hospices or any other medical facilities. RFID tiles may be deployed in amusement parks, ski resorts, cruise ships and/or other entertainment facilities. RFID tiles may be deployed in hospitality facilities and on transportation vehicles, such as hotels, resorts, cruise ships, ferries, trains, airplanes, busses, shuttles, taxis, limousines, private cars, yachts, etc. RFID tiles may be deployed in manufacturing plants, services business, oil platforms and other similar production facilities, mines, construction sites, construction related vehicles, military facilities and vehicles. RFID tiles may be deployed in banks and other high security areas such as vaults, prisons, courthouses, archives, warehouses and storage facilities, data warehouses, and data processing facilities.

RFID tiles may be deployed in educational facilities or related environments such as schools, universities, school buses, campuses, office buildings and campuses. RFID tiles may be deployed in retail and supply chain facilities. For example, RFID tiles may be used to identify patients, hotel guests, cruise ship guests, travelers, children, elderly people, personnel, objects, skiers, and to track their movement (e.g., where legal). Application platforms using RFID tiles can use this information to enable loyalty cards, make payments, authorize transactions of various sizes, customize personalized experiences, make automatic payment for services, provide access control for people and objects, associate certain objects or services with one or more persons, provide secure transport, enable secure asset tracking, enable mobile asset tracking, locate a server or asset, etc.

In some embodiments, and by way of illustration, RFID tiles may be deployed on a cruise ship or other location to identify a guest and/or adjust the environment to the liking of the guest. RFID tiles may be deployed on a cruise ship to identify a guest and engage the guest in an interactive game, a media presentation, a personalized media presentation and/or deliver a personalized experience, personalized advertising, announcement of a special offering and/or other personalized content. RFID tiles may be deployed on a cruise ship to track guests or personnel for security and safety monitoring. In certain embodiments, RFID tiles can be used to send an alert, if children or guests or staff appears in unauthorized areas. RFID tiles may be used to prevent access, if children or guests or staff appears in unauthorized areas. RFID tiles may be used to administer payment or a financial transaction tied to a specific person, event, purchase, service rendered and/or sale. In addition, RFID tiles may be used to administer a rental or lease fee relating to an object, a person or both.

RFID tiles may be used to associate one or more objects or one or more sensor inputs with each other or with one or more people. For example, a RFID tile may incorporate a sensor (e.g., for temperature, light, sound, radiation, motion, pressure, proximity, smell, chemical or otherwise). A RFID tile may communicate with a sensor wirelessly or otherwise. RFID tiles may be used to determine usage of one or more objects or services by one or more users. RFID tiles may be used to establish a vicinity of a person or an object relative to a specific location. RFID tiles may be used to establish a location and/or an identity of a person or an object in a specific location, including but not limited to a room, a general area, a theater, a specific theater seat, an attraction, an attraction vehicle, a goods serving location, a restaurant, a restaurant table, a restaurant seat, a vehicle, a vehicle seat, a train, a train seat, an airplane, an airplane seat, a ship or ferry stateroom, a park, an entertainment park, an airport, an airport terminal or gate, a train station, a station platform, a factory floor, an assembly line, a truck, a truck bed, a rail car, a container, a section of a truck or container, a construction site, surveying equipment, a residential home, an apartment building, a retail store, a retail shelf, a bookshelf, a clothes rack, a shoe rack, a hotel lobby, school room, lecture room, bus, bus seat, or a bus station.

In embodiments that include sensing capabilities, examples of sensor input can mean without limitation temperature sensing, humidity sensing, the sensing of curing of a material, orientation sensing, acceleration sensing, gyroscopic sensing, velocity sensing, power sensing, flow sensing, sensing of utility usage such as water, gas, or electricity, the sensing of usage of a consumable, biometric sensing, sensing for healthcare, sensing for physical activities, sensing for race timing, sensing for mining, carbon monoxide sensing, infrared sensing, and sensing of building and construction materials.

In some embodiments, RFID tiles may be used to identify a person and/or engage the person in an interactive game, a media presentation, a personalized media presentation, and/or deliver a personalized experience, personalized advertising, announcement of a special offering, and/or other personalized content. RFID tiles may be used to administer or monitor access of one or more person to a location such as a hotel room, stateroom, office, hospital room, event, theater, concert, amusement park, ride, public transport, private transport, construction-related transport, storage facilities, factory environments, military and law-enforcement facilities, hospitals, schools, educational campuses, ships, parking lots, garages and/or other locations.

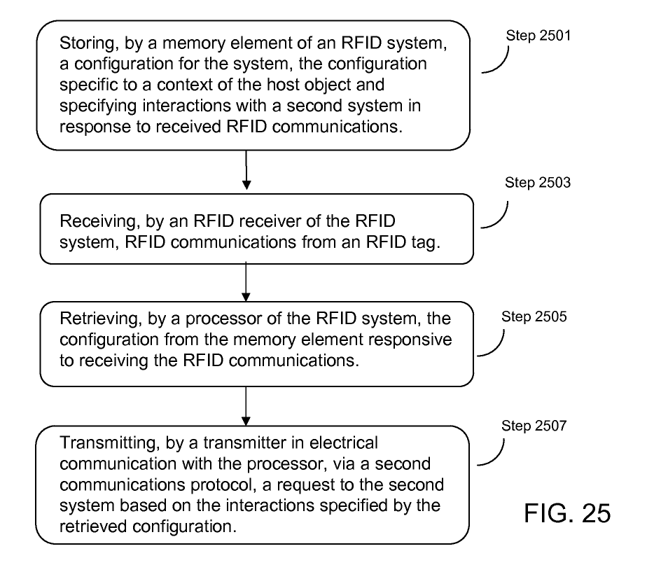

Illustrated in FIG. 25 is an embodiment of a method of a modular, configurable radio frequency identification (RFID) system receiving RFID communications and packaged in a casing for incorporation into a host object. The system may interact with other systems based on the received RFID communications. A memory element of the RFID system may store a configuration for the system (Step 2501). The configuration may be specific to a context of the host object, and may specify interactions with a second system in response to received RFID communications. An RFID receiver of the RFID system may receive RFID communications from an RFID tag (Step 2503). A processor of the RFID system may retrieve the configuration from the memory element responsive to receiving the RFID communications (Step 2505). A transmitter may be in electrical communication with the processor. The transmitter may transmit, via a second communications protocol, a request to the second system based on the interactions specified by the retrieved configuration (Step 2507).

In some embodiments, the RFID system may be referred to as a RFID tile. The RFID tile may receive power from a device incorporated into the casing. Such a device may include a battery, a solar cell, an inductive coupling device, or any other features describes above. The RFID tile may be designed to be substantially self-sufficient and/or power-efficient. In certain embodiments, the RFID system may receive power from the host object, for example, using a connector or other interface. The RFID device may consume power directly from the host object, or may store energy received from the host object or another source. In various embodiments, the RFID system may be designed for attachment or incorporation to a plurality of types of host objects. The contexts as to the types of host object may differ. For example, a host object may be fixed in location, may be moved, or may be in constant motion. In some embodiments, a host object may, for example, be in a residential context, a manufacturing context, a transportation or logistic context, or in a retail context. A host object may be a machine, fixture or living thing (e.g., an individual), with accompanying characteristics and/or capabilities which the RFID tile may rely on. A host object may be, or have the opportunity to come within a certain range of other appliances or objects. As such, the RFID system may be configured to operate accordingly. In some embodiments, a user, retrofitter or manufacturer may also replace or adapt the casing of a RFID system. This may be done for aesthetic or unobtrusive incorporation into a particular host object.

Further referring to FIG. 25, and in more detail, a memory element of the RFID system may store a configuration for the system (Step 2501). The configuration may be specific to a context of the host object. The specification may specify one or more interactions with the host object, another RFID tile, and/or a second system based on the context of the host object. The specification may specify the one or more interactions in response to received RFID communications, e.g., from RFID tags in the vicinity of the host object. In some embodiments, each RFID system may be configured with its own configuration, for example, based on the context of their respective host object. The configuration of a RFID system may be substantially the same as a configuration of another RFID system. In some embodiments, the configuration of the present RFID system may be different from a configuration of another system.

In some embodiments, the memory element may store a plurality of configurations. The RFID system may identify one of the plurality of configurations as a default, active or primary configuration, for example, based on the context of the host object. A user, manufacturer or retrofitter may select the default, active or primary configuration via a user interface of the RFID system. In some embodiments, the RFID system may select the default, active or primary configuration upon identifying its host object. A RFID system may have a cache memory for storing the default, active or primary configuration, e.g., for efficient retrieval by the processor of the RFID system.

A user, manufacturer, retrofitter or other entity may configure or reconfigure a specification of a RFID system. The specification may be programmed or re-programmed via an interface on the RFID system, such as a graphical user interface. In some embodiments, the specification may be programmed or re-programmed wirelessly or via a connection to a device (e.g., computer, remote control, handheld computing device) which may, for example, be operated by a user or an administrator. The RFID system can similarly download or receive a specification, or information for configuring or reconfiguring a specification, from another device. In some embodiments, a RFID system can update its specification through network communications with one or more other devices using a supported communications protocol. The RFID system can store and/or maintain any of these received updates, specification or information in its memory element.

At Step 2503, a receiver of the RFID system may receive RFID communications from an RFID tag. The RFID system may be configured to support one or more RFID communications protocols, and may communicate with one or more types of RFID tags, readers or other devices. In some embodiments, and by way of illustration, the RFID system sends or broadcasts a request to one or more RFID tags. The one or more RFID tags may send a response or other communications to the RFID system. A receiver of the RFID system may receive, via an antenna of the RFID system, a RFID communication from a RFID tag, another RFID system, or other device.

The RFID system may receive RFID communications including any type of information, such as identification of a tag or a tagged object, location information, readings from a sensor, or capabilities of one or more devices in the vicinity or connected via a network. The received communications may, in some embodiments, be of a non-RFID protocol. In some embodiments, the RFID system may store information from the received communications, for example, in the memory element. The memory element may store or buffer communications or information received over a period of time. A processor of the RFID system may extract, analyze, evaluate or otherwise process information from the RFID communication, and this may be performed dynamically as the information is received, upon a predetermined event, or according to a schedule.

At Step 2505, a processor of the RFID system may retrieve the configuration from the memory element responsive to receiving the RFID communications. The processor may retrieve some portion of its configuration from the memory element responsive to the received communications. The processor may process the information based on the configuration of the RFID system, which may specify what information to extract. The configuration may specify how the information is evaluated or processed, and may indicate interactions or action to take. Based on the information from the RFID communication, the processor may select, retrieve or consult another portion of the configuration. In some embodiments, based on the information from the RFID communication, the processor may select or retrieve a different configuration stored in the memory element. In some situations, the processor may determine, based on the received communications, that a new or updated configuration is available, and may communicate with another device to receive the new or updated configuration.

The processor may determine, based on the configuration and/or the information, one or more actions for the RFID system to take. In some embodiments, the configuration may include one or more rules or policies. The processor may apply the one or more rules or policies on information extracted or processed from the received communication. Based on the rules or policies, the configuration may indicate follow-up operations for the RFID system to perform. Based on the configuration, the processor may generate a request, command or other communication, directed to the host object, another RFID system or tile, another device, or the source of the received communication. The communication may be generated using a RFID communications protocol or another protocol.

At Step 2507, a transmitter may transmit, via a second communications protocol, a request to the second system based on the interactions specified by the retrieved configuration. The transmitter may be in electrical communication with the processor. The processor may accordingly instruct or request the transmitter to send the generated request, command or communication. The transmitter may transmit the request to a second system to initiate an operation based on the configuration of the system. The transmitter may transmit the request to a second system to convey at least a portion of the received RFID communications to a third system for example. Based on the configuration, the processor may indicate to the transmitter to direct the communication to the host object, another RFID system or tile, another device, or the source of the received communication.

By way of illustration, and in some embodiments, the transmitter may convey a request to the host object, which may be an answering machine, to initiate playback of voice messages. The transmitter may send a portion of the received information to a processing center, or may pass a portion of the received information to another RFID tile or device en route to the processing center. The transmitter may wirelessly send a command to an appliance to adjust the lighting, music, temperature or other aspect of an environment. The transmitter may send a communication to the source of the received communications, to request for additional information or to provide requested information. In some embodiments, the transmitter send a request to another RFID tile, so that the receiving tile may initiate an operation in the latter tile's host object. For example, the receiving tile may trigger an alarm system based on detection of an unauthorized entity by the sending tile. A receiving tile may initiate one or more actions based on a configuration of the receiving tile.

In some situations, a user may incorporate a RFID system into a second or different host object having a context different from the context of the first host object. Based on the context of the second host, a different set of functionalities or capabilities may be appropriate or required of the RFID system. For example, the host object may limit the communications range of the RFID tile, or may limit accessibility to the RFID tile. In the latter case, the RFID tile may be reconfigured to operate in low-power mode, for example, to perform tasks according to a modified schedule. The new host may have a physical interface to the RFID tile, or may require specific wireless communications protocol support from the RFID tile. Thus, the configuration of the RFID tile may have to be updated to support communications with the new host. As described earlier, a user or the RFID system itself may reconfigure the configuration of the RFID system based on the context of the second host.

In some embodiments, the RFID system incorporated into the new host may receive a communications from the same RFID tag, another RFID tag, or from another device. For example, the RFID system may receive RFID communications from the same RFID tag, and may transmit another request to the same destination system or to a different system. The RFID system may transmit the new request based on interactions specified by the reconfigured configuration which may differ from interactions previously specified by the original configuration. Accordingly, a system of one or more RFID tiles can be configured to operate individually or in concert, to provide desired functionality based on a context of its environment.

Co-Locating a RFID Field with a Human-Perceptible Field Representation

RFID technology is conventionally used to locate the position or movement of tagged objects. In some RFID implementations, there is an assumption that tagged objects are or will come within range of a RFID reader or detection devices, which may not be easily controlled or ascertained. A priori knowledge of the location or motion of RFID devices can be used to define the interaction zone between any pair of RFID devices, and can render further human intervention unnecessary. Without prior knowledge, RFID signals and fields are invisible to the human eye and generally undetectable by a person without the aid of a detection device. This limitation can preclude applications in which a person may otherwise assume a more active role in making decisions and/or performing actions with respect to the presence of an RFID field or signal. By enabling a person to perceive an otherwise invisible RFID signal, a person may be provided with an ability, incentive and/or motivation to interact with a RFID signal or device. A human-perceptible representation of a RFID field may be determined and/or conveyed to a person, allowing the person to recognize and identify a characteristic and/or source of an RFID field via the representation. With the ability to locate and/or identify certain characteristics of an RFID field, a person can determine whether and how to interact with the RFID field.

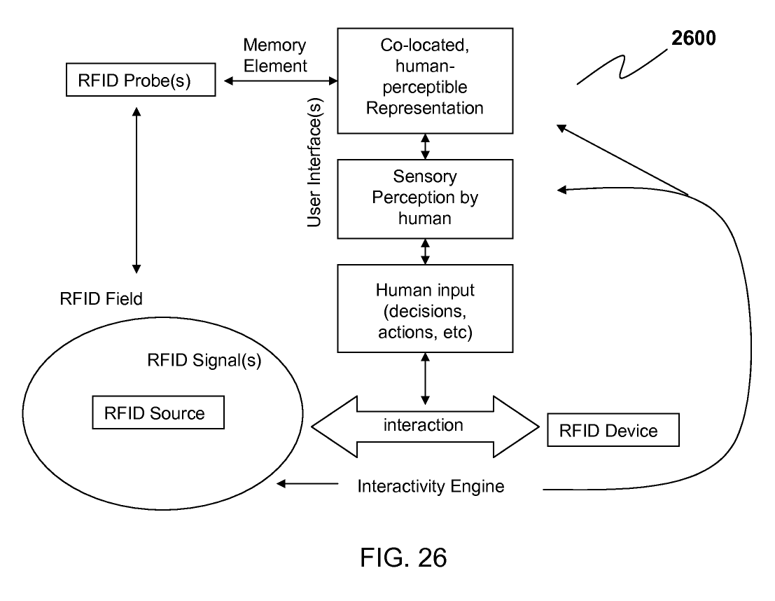

Referring to FIG. 26, one embodiment of a system 2600 for co-locating a RFID field with a field representation perceptible by one or more human senses is depicted. In brief overview, the system includes one or more probes for detecting a RFID signal or field, the one or more probes in communication with an interface for providing a human-perceptible representation of the RFID signal or field. A person using the interface may decide to interact with the RFID signal or field via the co-located human-perceptible representation, for example, using any RFID device, or a device that alters or affects the RFID signal or field. In some embodiments, the system includes an interactivity engine for monitoring or detecting the interaction. A RFID signal may include an electric and/or magnetic signal. A RFID field may include an electric and/or magnetic field. The electric and/or magnetic field of a RFID field may remain static over some period of time, vary in a cyclical manner over time, or change in various other ways, depending on the source of the RFID field, and any interactions with another field, media, materials and/or devices.

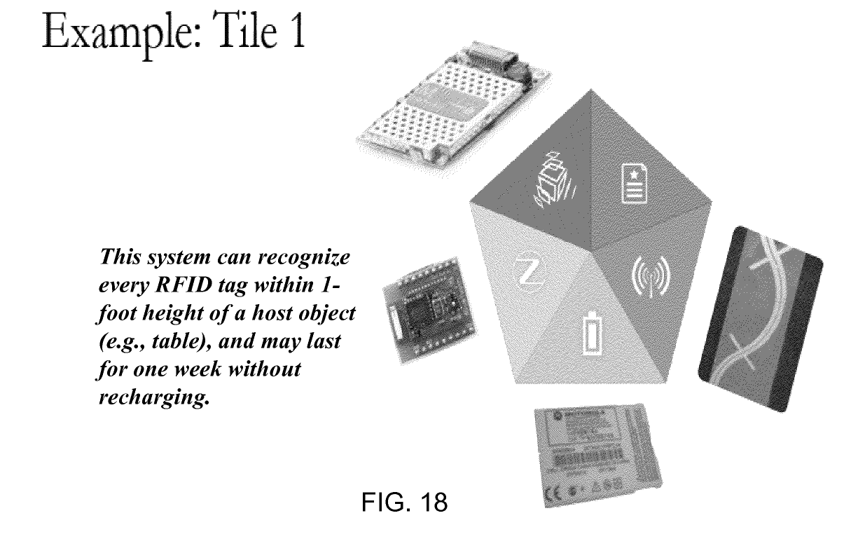

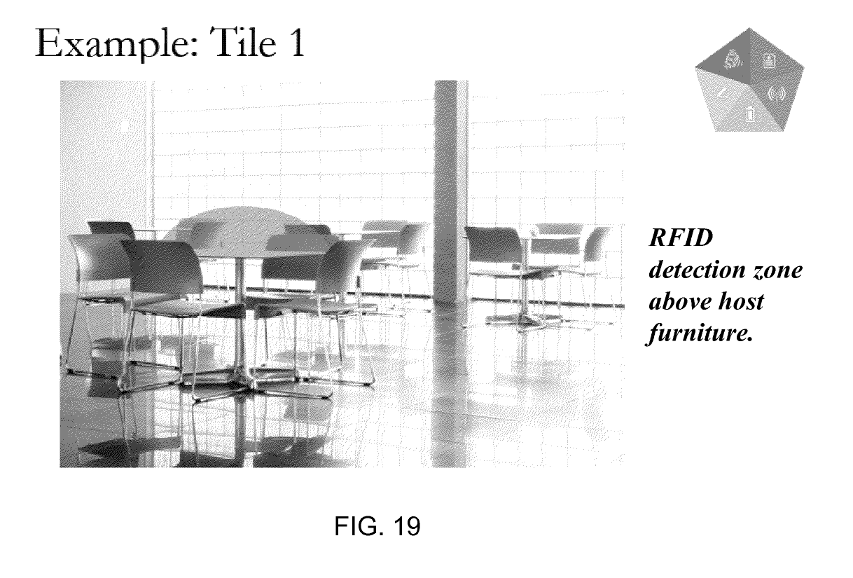

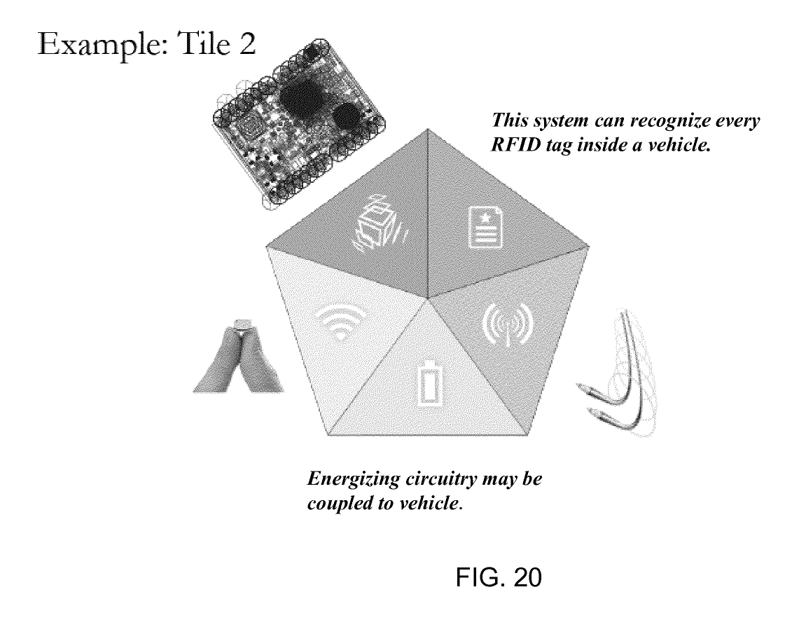

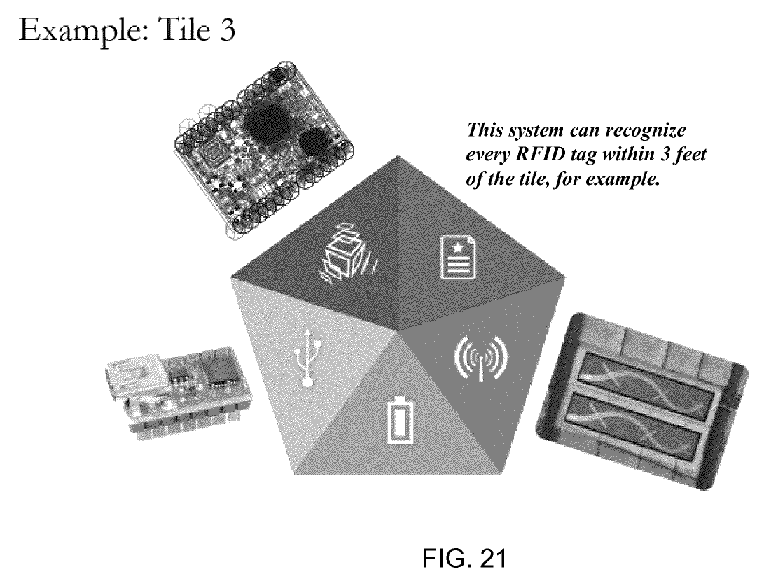

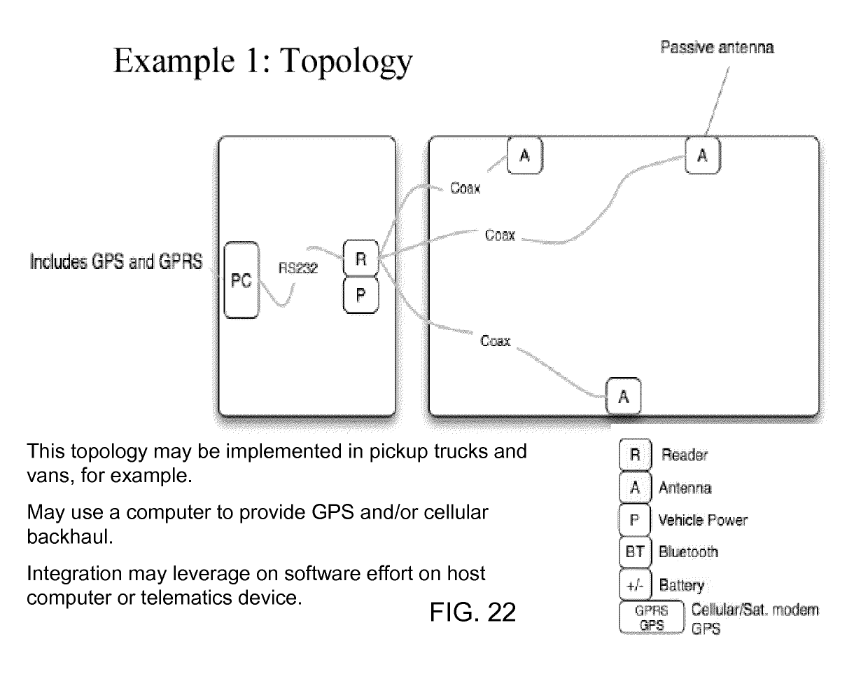

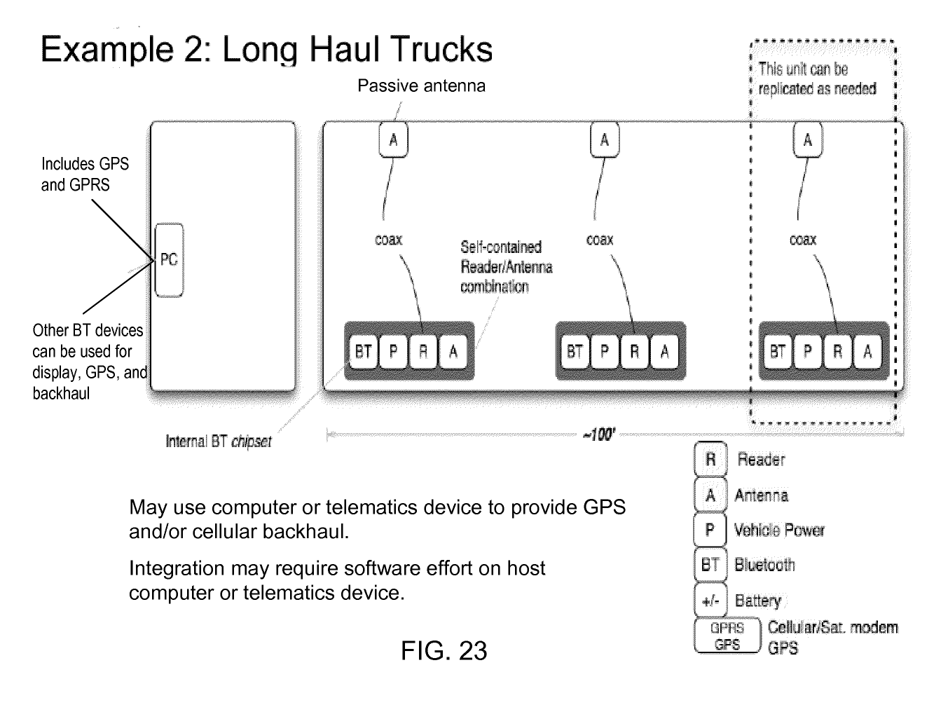

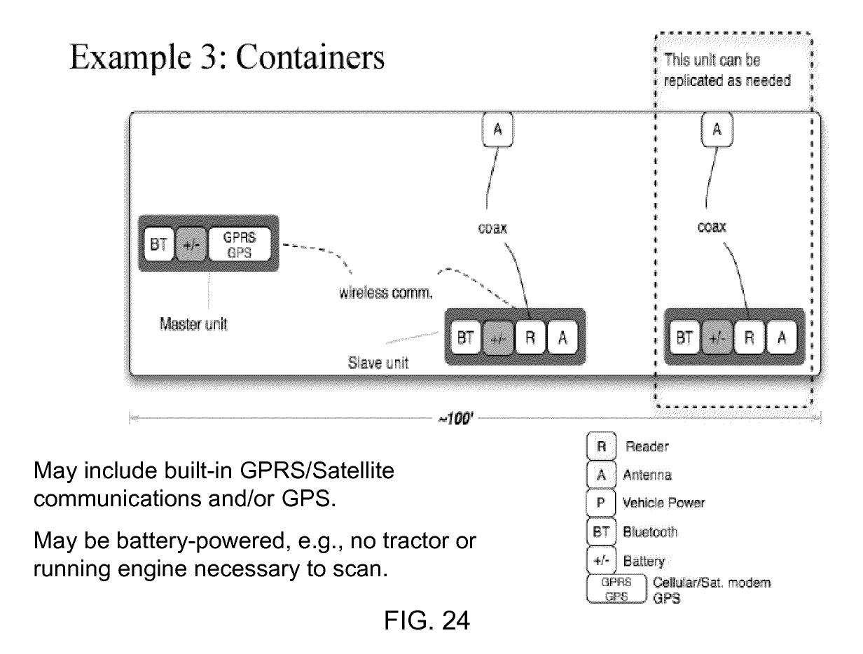

In some embodiments, the system 2600 includes a probe for detecting a signal from an RFID source or signal field. A signal field, as referred to herein, does not have to encompass the full extent of signals or radiation from a signal source, and may refer to any portion of a larger signal field. A probe may include one or more receivers, such as an array of antennas, for detecting RFID signals. The probe may comprise any type or form of RFID detector, receiver and/or reader. According to certain embodiments, the probe may include one or more features of any embodiment of the RFID devices described above in connection with FIGS. 1-3, 9-12, 18, 20 and 21. In some embodiments, the system 2600 may include a plurality of probes. The plurality of probes may be spatially located across a two or three dimensional region. The location of each probe may be known and may remain static for at least a period of time. In some embodiments, a plurality of probes (e.g., RFID tags and/or readers) may be attached to a grid structure for detecting a RFID signal or field. The location of each probe may be identified in relation to a known reference point. For example, a location of a tag in the grid structure may be determined or calculated with respect to the known center location of the grid structure.

In certain embodiments, a probe's position, or a reference point for determining a location of the probe, may be determined by GPS or other location positioning methods. For example, a mobile RFID reader may incorporate a GPS unit to record the position of any detected signal or field. A probe may be moved across a region to detect an RFID signal, for example, carried by a person, a conveyor belt, a vehicle, a robot, etc. A probe may move across a region by flight, propelled in a trajectory, flotation, etc. A plurality of probes may be scattered across space and over any medium (air, liquid, etc) to detect and/or search for RFID signals. For example, a web of probes may be propelled in air to detect and/or map a RFID field. A plurality of probes may disperse downwards from the surface of a pool of water to detect RFID signals or RFID sources within the pool of water.

Each probe may be self-propelled for movement, or may leverage on other means such as fluid flow or gravitational pull. The movement between probes may be coordinated or independent of each other. The movement of the probes may depend on the characteristics of the mode of travel, e.g., topology of a surface, fluid direction and density, wind direction, etc. Each probe may include intelligence for seeking out RFID signals and/or identifying characteristics of the signals. In some embodiments, a probe may be designed and constructed as a low-cost disposable device. For example, a single or limited-use probe may become inactive or expire (e.g., due to drained batteries or lack of induction to energize the probe). A single or limited-use probe may be deactivated after use, for example, via a wireless control signal, or by using a destructive radiation pulse. In some embodiments, a probe may be designed for re-use or extended use over a period of time.

A single probe can be used to scan a region for RFID signals. For example, a probe may be manually positioned at various locations within a region to detect a RFID signal or field. Locations of the probe, where a RFID signal is detected, may be recorded, e.g., using photographic snapshots or a location positioning method such as GPS. In some embodiments, a plurality of photographic snapshots identifying locations where signals are detected may be superimposed to represent the extent of the corresponding signal field.

Locations of a signal field can be stored in a data structure, such as a list, hash table or other database. The data structure may further be updated with new or changed locations. This data structure may reside in memory or any other storage device. Location information collected via a probe may be transmitted, in real-time or at prescribed times, for storage in a storage device. The locations of a signal field may be stored temporarily or for any configured length of time. Similarly, any characteristic of a signal (e.g., operating frequency or protocol) corresponding to each signal location may be stored and/or updated in the data structure. In some embodiments, signal locations and other characteristics may be stored across a distributed and/or hierarchical database. For example, these information may be stored locally in each probe and retrieved where appropriate for storage in another location or for further processing. In certain embodiments, these information may be stored over a storage area network (SAN). In some embodiments, a probe may not have local storage and/or processing capabilities. Information collected by a probe may be processed and presented to a person in real-time or substantially in real-time (e.g., with a time-lag). In certain embodiments, signal locations and other characteristics may be stored temporally, for example, recorded in a time-lapse video. Such temporal information may be useful in tracking signal changes and/or predicting signal change.

In some embodiments, a probe is physically connected to a storage and/or processing module, for communicating information collected in connection with a detected RFID field. In some embodiments, a probe is designed and built to wirelessly transmit collected information to a storage and/or processing module. A plurality of probes may interoperate to convey collected information to a storage and/or processing module. For example, a probe may communicate with a proximately-located or adjacent probe (e.g., acting as an intermediary) to transfer collected information to another device. The storage and/or processing module, which may be incorporated in a user interface, may include a memory element of any type or form. In some embodiments, the memory element can be any one of the following types of memory: SRAM; BSRAM; or EDRAM. Other embodiments include memory elements of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); or any other type of memory.

In some embodiments, a plurality of probes are arranged or configured in hierarchical fashion to collect, store, convey and/or process RFID signal data. For example, a pair of probes may operate in a master-slave configuration for collecting particular RFID information specified by a master probe and for transferring the collected information to the master probe.

In some embodiments, the system 2600 includes one or more interfaces for providing a human-perceptible representation of a detected RFID signal or field. The one or more interfaces may provide a user interface to one or more persons. An interface may comprise a storage and/or processing module for handling the RFID information from the probe. In some embodiments, the system 2600 may include one or more positioning systems for identifying a probe's location at a particular point in time. The processing module of the interface may associate or pair RFID information collected at a particular point in time with a respective physical location of the probe. In some embodiments, the processing module stores the paired information in a storage module for later processing. Such a storage module may reside in the interface or on one or more network devices in communication with the interface. The storage module may store and keep track of collected information from a particular probe or location over a predefined period of time.

In certain embodiments, a probe may detect a characteristic of a signal field at a physical location. Characteristics of a signal field may include field source, signal strength, operating frequency, RFID protocol, temporal movement and operational range of the signal field. The probe may collect or measure a value of a characteristic of the signal field. A processing module of the system may further process a collected value or information into a data point. Each data point may, for example, include a collected value or a processed value, and may include a location corresponding to a physical location of the signal field. A representation of the signal field may be stored in a memory element. For example, the representation may include a plurality of data points each recording a value of a characteristic of the signal field at a respective physical position. In some embodiments, the representation may include a subset of data points processed from collected values. For example, the representation may feature data points that describe a boundary of the signal field, or that represents a particular characteristic (e.g., signal strength) of the signal field. In certain embodiments, the system generates certain data points by interpolating or extrapolating other data points or values. The system may store or buffer a plurality of data points in a memory element, e.g., prior to rendering on a user interface.

The interface may include a processing module for generating a human-perceptible representation of a detected RFID signal or field. The processing module may produce a representation that a human can perceive using one or more senses, such as the sense of sight, touch, hearing, smell and taste. In some embodiments, the interface includes one or more probes. In one basic form, the interface includes a probe and a LED that illuminates as the probe detects a RFID signal. The brightness, blinking frequency and/or color of the LED may, for example, correlate with the strength or other characteristic of a detected signal. In one embodiment, the LED may contribute to a human-perceptible field representation of a detected RFID signal or field.

In certain embodiments, a field representation is a two or three dimensional representation that a human can see or sense. A field representation may identify a volume, boundary or surface of an RFID field, or any portion thereof. A field representation may be continuous, such as a surface, volume or line. In certain embodiments, a field representation may be extrapolated or otherwise generated from one or more point representations of RFID signals that are detected. In some embodiments, a field representation may comprise a plurality of segmented and/or point representations of a signal field. For example, a field representation may include a collection of spatially-located indicators or point representations. A collection of point representations may collectively define a volume, region or boundary of a field. In some embodiments, each point representation may represent a localized characteristic of the RFID field. A collection of point representations may, for example, cluster in various densities to describe different localized signal strengths.

A field representation may, by way of a non-limiting example, perform one or more of the following: 1) provide an outline of at least a portion of an RFID field, 2) identify a volume of at least a portion of an RFID field, 3) identify an operational range or boundary of an RFID field, 4) indicate localized signal strength or power of an RFID field, 4) identify (e.g., uniquely) a particular RFID signal, field or source, 5) distinguish between portions of two RFID fields, proximate to each other or overlapping each other, produced by different RFID sources, 6) identify the protocol of a RFID signal, 7) identify the operating frequency of a RFID signal, 8) represent any characteristic of the RFID signal or field as it changes over time, and 9) provide a representation of a temporal characteristic (e.g., rate of movement of a field) of a RFID signal or field. A temporal characteristic may be represented, for example, by transient visual effects and/or haptic vibrations. In addition, one or more probes may collect RFID information continuously or at various intervals to update or refresh a field representation. The rate of update, or the refresh rate of the field representation, may be configured according to various needs. For example, a high refresh rate may be required for real-time and fast-paced applications in a gaming context.

The processing module of the interface may produce a field representation that is co-located or substantially co-located with the detected RFID field or signal. The representation may be co-located with the RFID field over a three-dimensional volume or surface, or a two-dimensional area or boundary. In some embodiments, the field representation may be co-located with one or more portions of a RFID field. For example, the interface may generate a field representation that includes illusory contours and/or corner indicators. A person may be able to use these as visual or physical cues to identify one or more portions of an RFID field and to infer a larger extent of the RFID field. For example, and in some embodiments, a field representation may include a plurality of point-indicators, vertex-indicators or corner-indicators. By way of illustration, point-indicators indicating the vertices of a triangular field (in two dimensions) may allow a person to infer the boundaries of the triangular field. Vertex or corner indicators, such as identifying the four corners of a rectangular RFID field, may allow a person to infer the complete rectangular outline of the RFID field.

In further details, the interface may use any combination of colors, hues, brightness, shapes, sizes, movement, sounds, sound levels, pitch, sensations via touch, transient effects, ambient features, temperature and/or taste to represent or characterize an RFID signal or any portion of a RFID field. The interface may comprise any type or form of user interface providing human-perceptible feedback to a person. In certain embodiments, the interface may provide feedback to a user via one or more of the following senses: nociception (pain or discomfort); equilibrioception (balance); proprioception and kinaesthesia (motion and acceleration); sense of time; thermoception (temperature differences); and magnetoception (direction). In certain applications, the interface may operate in one or a combination of modes. In some embodiments, the interface may operate in prospective mode, zone mode, interactive mode, customized mode, though not limited to these enumerated modes. In prospective mode, the interface may identify, via field representations, RFID fields within a region and proximate to a user. In zone mode, the interface may provide feedback upon user contact with a boundary or zone of a RFID field, e.g., via haptic feedback. In interactive mode, the interface may actively respond to user interaction with respect to any characteristic of a RFID field, an associated object or an associated person. In customized mode, the interface may provide any form of interactive feedback, including field representations, in relation to the identity of the user (e.g., user preferences and user history).

In some embodiments, the interface includes a graphical user interface (GUI) or visual interface, such as a display, e.g., LCD, LED, OLED, plasma, cathode ray tube, projection system, illumination device, three-dimensional display system, etc. The display may provide, project or simulate a two-dimensional or three-dimensional (e.g., holographic or stereoscopic) representation of an RFID field. The display may co-locate a field representation with an RFID field by visually overlapping the field representation with the extent or boundary of the RFID field. The display may co-locate a field representation with an RFID field using any techniques employing virtual images (e.g., using mirrors, such as concave mirrors), layered images (e.g., semi-reflective mirrors), projected images (e.g., holographic or two-dimensional projections), illumination, video effects (e.g., real-time playback with field representation superimposed on recorded image), etc.

In some embodiments, the display is integrated into a visor, goggles, mask, face-plate, lenses or glasses worn by a user. The display may be complemented by one or more feedback devices, such as haptic feedback devices (e.g., gloves and other body pads), temperature or infra-red modules (e.g., on body pads, that may generate heat or remove heat from the body) or temperature zone control systems, earphones or directional sound systems, olfactory devices including directional systems or devices coupled to or close to a user's nose, and gustatory devices conveying taste sensations (e.g., via spray or taste pads). In various embodiments, the interface may include any one or more of these feedback devices and/or systems.

In some applications, the sensations conveyed to a user may be designed to be distinctly recognizable, fun, entertaining, refreshing, pleasurable and/or exciting. Some of these sensations may be suitable in applications for entertainment purposes or for relaxation. For example, a person may visualize, via the interface, one or more musical regions (e.g., each represented by a RFID field) that generate a musical note if the person waves a wand (e.g., embedded with a RFID device) through a respective region. In another example, a person may wear haptic body pads coupled to RFID devices that responds as the person moves through one or more RFID field regions (e.g., representing obstacles in a virtual reality, role-playing game). In a virtual reality game, for example, the interface may generate various visual imagery, sound, smell and/or temperature as a player enters different zones corresponding to various RFID fields. In yet another embodiment, a person wearing a RFID tag may identify RFID regions around or near certain objects and may interact with these objects in a personalized way (e.g., via recognition of the person's unique RFID tag) as the person approaches and enters the respective RFID regions. For example, an object may respond and address the person by name or interact according to the person's known preferences or interests. A RFID tile may be configured to interact with a tagged user in particular ways.

In some embodiments, and by way of example, a RFID tile on a host computing device may indicate via a field representation that new emails are available for a user, which may interest the user to check his email. As the user approaches the computing device, a wrist tag of the user may interact with the RFID tile to communicate with the computing device to automatically unlock the screen of the computing device and/or run the email application. In another embodiment, a field representation may be presented as a visual icon at a distance which induces a person to approach. This field representation may convert to customized advertising as the person's RFID tag enters a corresponding RFID field. In another embodiment, the visual icon may be activated by the person (e.g., using a RFID-enabled glove or wand), for example, to open a door, begin a video playback or to power-up a machine.

In certain embodiments, a RFID field may be represented by at least a portion of a physical object. A RFID field may activate luminescent particles suspended in a solid or liquid body. In some embodiments, luminescent particles suspended in gas may be similarly activated to define the extent of a RFID field. A translucent object may be illuminated to co-locate illuminated portions of the object with a RFID field. Shapes may be created on or around objects to identify boundaries of an RFID field. For example, illusory contours using physical objects, surfaces, shadows and/or light may be arranged to define a region occupied by an RFID field. Illusory contours can also be used to define a RFID region beyond the boundaries of a physical object hosting a RFID source. For example and in one embodiment, illusory contours may be used to define a RFID-enabled region around a transparent (e.g., glass) object or RFID source (e.g., transparent antenna, such as one formed by applying an AgHT-8 optically transparent conductive coating over polyester).

In some applications, a RFID or signal field may be referred to as a RFID-enabled region. The boundary of a RFID-enabled region may be defined by a predetermined threshold for minimum field strength. Such a region may be of any shape and/or size. For example, a RFID-enabled region may include an interior of a room or a container. Certain objects and/or materials (e.g., metal) may influence or limit the shape, size and/or extent of a RFID field. A RFID-enabled region typically extends from a RFID source, and may be directional in nature. A RFID source may include one or more antennas designed and configured to substantially produce a RFID field of a certain shape, size and/or range. A RFID-enabled region may include a region capable of forming a RFID field. For example, a region around a RFID tag may produce a RFID field when the tag is energized via induction by another RFID device. Thus, although such a region may not always have an active RFID field (or a self-powered RFID source), another RFID device may enter the RFID-enabled region to activate the field and/or interact with it.

In some aspects, field representations may be designed to be aesthetically pleasing, striking, attractive, compelling, pleasant, exciting, curiosity-inducing and/or attention-grabbing. In some applications, these field representations are designed to encourage, motivate, persuade and/or induce a person to approach and/or interact with the field representations. By entering the RFID-enabled regions, a person may interact with the corresponding RFID fields using a RFID device. In some embodiments, a person may interact with a RFID field without using a RFID device. For example, the person may use a metallic shield to alter the shape of the RFID field. This in turn may create a change in the field representation, for example, and may be translated into a change in a sound or a visual image perceived by the person via the interface. Such feedback or interactivity may encourage or induce the person to further interact with the RFID field or other fields in proximity via the respective human-perceptible field representations.

In certain embodiments, field representations may be designed to be aesthetically unattractive, disturbing, disorientating, confusing, scary, taunting or boring. Some of these may be used in applications to dissuade or discourage a person to approach and/or interact with the field representations. Such representations may, for example, may be used in a horror-effects context, to indicate a danger zone, or for contrast with other field representations.

In some embodiments, a user may hold, wear or otherwise manipulate a RFID device for interaction with the RFID field or source via the field representation. A RFID device may include a device or material that can alter or affect a signal field in some ways, e.g., shape, signal strength, frequency or range. A RFID device may interfere with a signal field, for example, by generating field interference using another signal field. A RFID device may include a device that can detect, measure or react to a characteristic of the signal field. In some embodiments, the RFID device includes a RFID tag and the RFID source includes a RFID reader device. In some other embodiments, the RFID source includes a RFID tag and the RFID device includes a RFID reader device. The RFID device and RFID source pairing may include any combination of RFID devices that can communicate or interact with each other. One of the pair may provide identification and/or other information to the other. One of the pair may energize the other via induction or other coupling mechanism. The RFID device and/or RFID source may incorporate systems that enable or enhance user interaction. In some embodiments, the RFID device and/or RFID source are part of any such systems that enable or enhance user interaction. In certain embodiments, the RFID device and/or RFID source communicates with such systems. For example, the RFID source may communicate with an audiovisual system and/or motion detector to produce customized information and/or interactions for an identified user. The RFID device of the user may allow the user to wirelessly interact with systems connected to the RFID source.

In some applications, a field representation may be used to indicate the presence of an object or a person associated with a co-located RFID field. For example, a person may be wearing a RFID tag that defines a RFID-enabled region. By way of a non-limiting example, one embodiment of a field representation of a RFID tag worn on a person's wrist may be an orb of light around the RFID tag. One embodiment of a field representation of an obstacle may be a haptic force field around the obstacle. Inventory may be tagged and visually-identified at a distance by a person without the person waving a RFID reader in close proximity to identify the inventory. A cluster of RFID tiles or probes spatially-deployed over a region may be configured to detect a certain object or person moving through them. Thus, an object or person may be tracked and highlighted (e.g., visually by an orb of light in a crowd of people) using a field representation. The object or person may be tracked and highlighted even when it is partially obscured or obstructed from a direct line of sight. For example, the object or person may be tracked by another person wearing a visor incorporating an interface described above. By way of example, a lost child may be highlighted by a co-located field representation, and located in a crowd by a parent using an interface described above. By generating a distinctive field representation or field signature, the location and/or movement of an object or person may be more easily recognized, tracked and/or recorded (e.g., on video)

In some embodiments, a person with a shopping list may configure an interface to include the field representation of tagged products in the person's shopping list to facilitate location of the tagged products. The interface may provide real-time updates of the relative position between the person and a desired product as the person moves. The interface may provide haptic, audio and/or other types of feedback to a blind shopper to aid the shopper in locating a product, a product type, an aisle, department, etc. If a shopper approaches a field-represented product for closer interaction, the RFID field interaction may produce and/or customize product-related information to present to the shopper. Such information may be presented via the interface or other audiovisual devices located near the product.

A user may wear a RFID device or carry an interface that identifies the user. The RFID device and/or interface may incorporate information that customizes the user's experience, e.g., shopping, entertainment, vacation, or business convention experience. By way of illustration, the interface may indicate the presence of neighboring items of interest (e.g., based on purchase history and/or user preferences) as a user approaches an object or a product that is RFID-enabled. RFID-enabled field representations customized for (or targeting) a user or a category of users may have a higher chance of inducing user interest and/or interaction. Even without targeting a particular user or a category of users, compelling field representations are likely induce user interest and/or interaction. Field representations, by engaging one or more of a user's sensory functions, may also influence user decisions and/or encourage interactivity. In certain contexts, field representations that identifies persons and/or their interests (e.g., in a social or business setting) may aid person-to-person interactions and may facilitate successful connections. Field representation of persons in certain work environments may also enhance cooperation and teamwork. For example, a team of persons assembled for a project may be able to recognize skill sets, professional affiliations and functions associated with unfamiliar individuals via their field representations, and interact and operate more effectively with each other. This concept can also be applied in team sports and gaming contexts. For example, a user may use a haptic or audio interface to alert him or her of a teammate's position relative to the user, e.g., to avoid crashes or to facilitate a ball pass.

In some embodiments, the system includes an interactivity engine. The interactivity engine may detect an interaction between the RFID device and the signal field, and may generate an action based on the detected interaction. An interactivity engine may include a motion sensor for detecting an interaction. For example, the interactivity engine may detect movements from a user or a RFID device, which may be relative to the signal field or field source. In certain embodiments, the interactivity engine detects interactions via changes in the signal field, using probes or otherwise. In some embodiments, the interactivity engine communicates with the field source and/or the RFID device to detect interactions between the RFID device and the signal field. For example, the interactivity engine may be in communication with an accelerometer on the RFID device, or may track an infrared signal of the RFID device. The interactivity engine may also detect field interference resulting from the interactions.

In some embodiments, the interactivity engine can detect a movement of a portion of the RFID device towards or away from a portion of the signal field. The interactivity engine can detect the speed and/or acceleration of the movement or interaction. In certain embodiments, the interactivity engine can detect movement in certain directions. Movements can be detected based on sensitivities pre-configured in the interactivity engine. In certain embodiments, the interactivity engine detects movement of a portion of the signal field resulting from an interaction.

Based on a detected interaction, the interactivity engine may generate an action or output. The interactivity engine may generate an action responsive to each detected interaction, or according to the cumulative effect of multiple detected interactions. An action may be generated in real time or substantially in real time, or may incorporate a time delay relative to detected interactions. In some embodiments, the interactivity engine may generate a human-perceptible output to the user based on the detected interaction. For example, the interactivity engine may generate a sound or visual display (e.g., presented in the user interface or otherwise). The interactivity engine may modify the signal field based on the detected interaction, and the user may perceive the modified signal field via the user interface. In certain embodiments, the interactivity engine may communicate a request to modify or update the representation of the signal field stored in the memory element based on the detected interaction. The generated actions may provide motivation or disincentives for additional interaction, similar to embodiments of the human-perceptible representation discussed earlier.

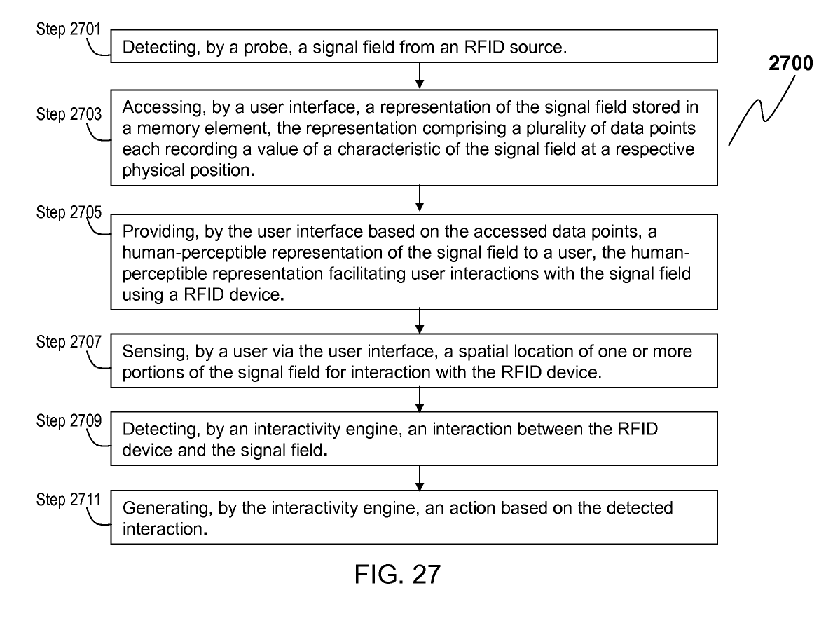

Referring now to FIG. 27, one embodiment of a method for co-locating an RFID field with a field representation perceptible by one or more human senses is depicted. The method includes the step of detecting, by a probe, a signal field from an RFID source (Step 2701). A user interface may access a representation of the signal field stored in a memory element (Step 2703). The representation may include a plurality of data points each recording a value of a characteristic of the signal field at a respective physical position. The user interface may generate a human-perceptible representation of the signal field to a user (Step 2705). The human-perceptible representation may facilitate user interactions with the signal field using a RFID device. A user of the interface may sense a spatial location of the portion of the signal field for interaction with a proximately-located RFID device (Step 2707). An interactivity engine may detect an interaction between the RFID device and the signal field (Step 2709). The interactivity engine may generate an action based on the detected interaction (Step 2711).

In some embodiments, the methods described herein include, but are not limited to an acquisition stage and a display stage. The acquisition stage may include functions of detecting a RFID field and/or acquiring at least some location information of the RFID field so that the shape of the RFID field may be defined. In some embodiments, the acquisition stage includes a determination of the shape of the RFID field. The display stage may include functions of processing the location information of RFID signals to determine the shape of the RFID field and/or generating a human-perceptible field representation of the RFID field. In some embodiments, the display stage renders the shape of the RFID field (e.g., determined in the acquisition stage) in a human-perceptible form, i.e., a field representation. The functions of the acquisition stage are hereafter sometimes generally referred to as “acquisition”. The functions of the display stage are hereafter sometimes generally referred to as “display”.

In some embodiments, acquisition and display processes are decoupled from each other. In other embodiments, acquisition and display processes may be integrally coupled. These processes may operate in accordance to at least four modes: 1) real-time acquisition and real-time display, 2) non-real-time acquisition and pseudo-real-time display (e.g., via interpolation or extrapolation, etc), 3) real-time acquisition and pseudo-real-time display (e.g., when slower refresh rates are possible), and 4) offline acquisition, storage, and real-time “playback”.

In some embodiments, mode 1 describes acquisition and display processes occurring in real-time. This may include operations performed substantially in real-time. Acquisition and display processes may separately proceed in real-time, e.g., performed by different components of the system 2600. In certain embodiments, substantial portions of acquisition and display may be performed by a single process in real-time and/or performed by a particular component of the system 2600 in real-time. Substantial portions or all portions of a field representation may be continuously updated. In some embodiments, the refresh rate for a field representation may be appropriately high, and any introduced time lag sufficiently small or non-existent to be considered real-time.

In some embodiments, mode 2 describes acquisition processes that introduce discontinuities, delays and/or time-lags that may vary over time. Some of the data collected and/or generated during acquisition may be stored or buffered prior to further processing or use. Some of the acquisition processes may be disjointed and/or decoupled from some other acquisition processes. Display processes may occur in pseudo real-time. In some embodiments, one or more display processes may operate as and when data is available from acquisition. In certain embodiments, data from acquisition may be buffered for processing. The processing speed of a display process may be adjusted based on the incoming data, which may be buffered or not. In some embodiments, a portion of a field representation is generated or updated responsive to available incoming data. The display processes may generate or update some portions of a field representation in real-time. The display processes may perform interpolation and/or extrapolation based on available incoming data and/or presently-available data that may not be up-to-date. Some of the display processes may operate in a less than continuous manner. Some of the display processes may operate at a rate sometimes below that of incoming data or the rate of change of the corresponding RFID field. In some embodiments, data is retrieved from a storage device as input to one or more display processes.

In some embodiments, mode 3 describes real-time acquisition processes that are substantially the same as those described in mode 1. Display processes may be pseudo real-time in nature. Display processes may operate in substantially the same manner as certain embodiments of the display processes described in mode 2. In some embodiments, one or more display processes may operate at a rate below that of one or more acquisition processes. The display processes may not process (e.g., selectively ignore or drop) some of the data generated or acquired during acquisition. Some of the display processes may be disjointed, may use stored or buffered data, may operate at a rate below that of incoming data or the rate of change of the corresponding RFID field, and/or provide a low refresh rate. This mode may be applicable in implementations in which slower refresh rates are possible or acceptable.

In some embodiments, mode 4 describes acquisition that is substantially offline or completely decoupled from display. Data from acquisition may be stored or buffered prior to retrieval for display processing. Acquisition may occur in real-time, at least over a particular period of time. The data may be stored until a request is received to present a field representation in playback mode. The data is retrieved and processed by display processes at a sufficiently fast rate to produce real-time playback of a field representation. In some embodiments, mode 4 is applicable for representing a static or substantially static RFID field. A snapshot of a static RFID field can be representation of the RFID field until the RFID field eventually changes or dissipates. Static characteristics of a RFID field, as well as some temporal characteristics, may be captured, stored and presented in playback mode without significant change from the RFID field's present, real-time characteristics.

In further details of step 2701, the system includes at least one probe for detecting, identifying, characterizing or otherwise probing a signal field from an RFID source. This step may occur as part of the acquisition stage described above. Each probe may probe at least one location within a defined region to detect whether a signal field exists. Each probe may perform probing in a continuous fashion or at certain instants in time. In some embodiments, the system 2600 may direct a probe to collect particular RFID information associated with a specific RFID field or source. A probe may determine a value of a characteristic of the signal field at a physical position. In certain embodiments, a location positioning system determines and/or records the physical location of a probe.

The at least one probe may store or buffer RFID information (e.g., including location information, values of field characteristics) collected from a signal field, for example, in a memory module of a respective probe. The at least one probe may convey RFID information collected to a memory element and/or processing module of a user interface. The memory element and/or processing module may process and organize the RFID information to form a representation of the signal field. The representation may include a plurality of data points each recording a value of a characteristic of the signal field at a respective physical position. In some embodiments, the memory element buffers or stores portions of the representation during acquisition.

In further details of step 2703, a user interface may access a representation of the signal field stored in a memory element. This step may be part of the acquisition stage or the display stage described above, or may be an intermediate step between these stages. The user interface may access one of a plurality of representations of the signal field. The user interface may access a representation based on the context of the user, for example, the user's identity, location, movement, orientation, or the type of RFID device the user is operating. The user interface may access a representation (e.g., audio or haptic) based on features supported by or enabled in the user interface (e.g., earphones, haptic pads). The user interface may similarly extract a portion of the representation of the signal field based on the context of the user and/or the interface. The user interface may switch between representations based on a change in the context.

The user interface may access any portion of the representation of the signal field based on one or more predefined events (e.g., initiated by the user, the signal source, the interactivity engine, the RFID device, etc). For example and in one embodiment, the user interface may access a representation of the signal field responsive to the user or the interface attaining a certain proximity to the signal field or signal source. The user interface may access a representation of the signal field stored in the memory element responsive to a user or a signal field activating the user interface. The user interface may access the memory element for an updated portion of the representation based on availability of update, and/or according to a configured frequency or a schedule. In certain embodiments, the user interface may remotely access the representation from a memory element located on another device (e.g., a probe or collation device). The user interface may access the representation from a memory element connected to or incorporated in the user interface.

Referring now to step 2705, the user interface may generate a human-perceptible representation of the signal field to a user. This step may be part of the display stage described above. The interface may generate a human-perceptible field representation of a portion of the signal field. The user interface may generate a representation perceptible by one or more of: human sight, hearing, touch, smell, taste, sense of temperature, and any of the other senses described above in connection with FIG. 26. The user interface may generate a two-dimensional or three-dimensional representation of any portion of the detected signal field. The user interface may generate, in various embodiments, a representation characterizing the signal field in one or more of the following aspects: field source, signal strength, operating frequency, RFID protocol, temporal movement and operational range, although not limited to these.

In some embodiments, the user interface uses the human-perceptible representation to distinguish the signal field from one or more other signal fields. The interface may retrieve RFID information stored or buffered in a probe or a storage module of the interface for processing. In some embodiments, the processing module may receive RFID information collected in real-time from at least one probe. The processing module may receive positioning information of a probe from a location positioning system in real-time. In some embodiments, the processing module may pair or synchronize the positioning information with RFID information received from the corresponding probe.

The processing module may generate, construct, assemble and/or extrapolate a field representation of the signal field using the RFID and positioning information collected. The processing module may update the field representation in real-time, at a predefined refresh rate, or according to the requirements of a particular application. In some embodiments, the processing module may generate a field representation that includes one or more characteristics of the signal field. The processing module may co-locate the field representation with the corresponding RFID field, for a user to perceive via one or more human senses.

Referring now to step 2707, a user of the interface may sense a spatial location of a portion of the signal field for interaction with one or more RFID devices. The user may operate one or more proximately-located and/or remote-controlled RFID devices. The user may physically approach, or cause a RFID device to approach the RFID field, by using the co-located field representation as a guide, indicator or locator. The user may wear, position or otherwise manipulate the RFID device for interaction with a portion of the signal field. The interface may update the field representation of the signal field in relation to the user's (or the RFID device's) location, movement (e.g., direction, speed and acceleration) and/or orientation. The interface may include or communicate with a motion sensor and/or a positioning system to update the field representation in relation to the user's (or the RFID device's) location, movement and/or orientation.

The interface may induce, motivate, interest or encourage a user to respond to the field representation. The interface may present the field representation in a pleasing, entertaining, fun, exciting, taunting and/or compelling way to elicit the user's response or interest. The interface may present options, ways, instructions and/or reasons for a user to interact with the field representation. The user may sense a representation of the signal field via any of the ways described above in connection with FIG. 26. For example, the interface may create a virtual reality interface for the user incorporating the use of one or more human senses.

Referring now to step 2709, an interactivity engine may detect an interaction between the RFID device and the signal field. The interactivity engine may detect an interaction using a motion sensor, which may include devices such as a infra-red/heat sensor or accelerometer. The interactivity engine may detect movements from a user or a RFID device, which may be relative to the signal field or field source. The interactivity engine may detect a movement of a portion of the RFID device towards or away from a portion of the signal field based on the human-perceptible representation of the signal field. In some embodiments, the interactivity engine communicates with the field source and/or the RFID device to detect interactions between the RFID device and the signal field. For example, the interactivity engine may be in communication with an accelerometer on the RFID device, or may monitor a signal (e.g., infrared signal) from the RFID device. The interactivity engine may receive feedback from the RFID device and/or the signal source regarding an interaction. The interactivity engine may, in some embodiments, detect field interference and perturbations resulting from the interactions.

In some embodiments, the interactivity engine can detect a movement of a portion of the RFID device towards or away from a portion of the signal field. The interactivity engine can detect the speed, rotation, direction and/or acceleration of the movement or interaction. In certain embodiments, the interactivity engine can detect movement in one or more directions. In certain embodiments, the interactivity engine detects movement (e.g., directional shift, range change, field reshape) of a portion of the signal field resulting from an interaction. The interactivity engine may detect a change in the signal field via one or more probes. In some embodiments, the interactivity engine detects a change in the signal field resulting from an interaction based on power consumed or emitted by the field source. The interactivity engine may detect a change based on a change in activity in the field source for maintaining or providing the signal field.

Referring now to step 2711, the interactivity engine may generate an action based on the detected interaction. Based on a detected interaction, the interactivity engine may generate an action, which may include a response, an output or a communication to another device. The user's (or the RFID device's) interaction with the RFID field may generate various responses from the interactivity engine. For example, the responses may be conveyed to the user via the interface and/or localized feedback systems (e.g., light arrays, audiovisual interfaces, mechanical systems, etc). The interactivity engine may generate an action responsive to each detected interaction, or according to the cumulative effect of multiple detected interactions. An action may be generated in real time or substantially in real time, or may incorporate a time delay relative to detected interactions.

In some embodiments, the interactivity engine may generate a human-perceptible output to the user based on the detected interaction. For example, the interactivity engine may generate a sound or a visual, such as an advertisement for a product, an alert, or a virtual reality object for entertainment purposes. The interactivity engine may modify the signal field based on the detected interaction, and the user may perceive the modified signal field via the user interface. For example, the interactivity engine may modify the output of the signal source. By way of illustration, the interactivity engine may communicate with the signal source to reduce signal power or to change the directional characteristic of the signal field.

In certain embodiments, the interactivity engine may communicate a request to modify or update the representation of the signal field stored in the memory element based on the detected interaction. The interactivity engine may collect and/or convey information about the signal field to update the representation of the signal field stored in the memory element. In some embodiments, the interactivity engine may determine particular values or data points to update in the memory element. For example, the interactivity engine may track the location of an interaction and request a modification of data points corresponding to the location of the interaction. The interactivity engine may add data points to the representation of the signal field, for example, to superimpose a visual (or other) representation over an original representation.

In certain embodiments, the interactivity engine may communicate with the user interface to modify the human-perceptible representation of the signal field based on the detected interaction. The interactivity engine may identify portions of the signal representation to modify or update. In some embodiments, the interactivity engine may communicate with the user interface to add, superimpose or otherwise include human-perceptible elements that the user can sense. The user may sense or perceive these elements separate from, or in conjunction with the signal field representation. By way of illustration, the user may see a representation of the signal field, but may sense haptic responses generated by the interactivity engine resulting from interactions with the signal field. In some embodiments, the human-perceptible representation of the signal field is modified by the additional elements and presented as an updated representation via the interface.

In some embodiments, a RFID-enabled region may comprise a plurality of RFID fields and co-located field representations with which a user may concurrently or individually interact. In certain embodiments, the interactivity engine and/or interface may identify the user (e.g., by communicating with a RFID tag worn on the user) and customize the user's experience. The interactivity engine and/or interface may be configured with information associated with the user (e.g., user history and preferences) to customize the user's experience. The interactivity engine may use the interface or output from the interactivity engine to customize the user's experience.

The user's (or the RFID device's) interaction with the RFID field may cause the interactivity engine, interface and/or localized feedback systems to solicit user input, attention or action. For example, the interactivity engine may generate actions that provide motivation or disincentives to the user for additional interaction, similar to that associated with the human-perceptible representations discussed earlier in connection with FIG. 26. In certain embodiments, the interactivity engine may generate an action, response or output directed to one or more other persons or objects. For example, in a multi-player gaming environment where players may be located at different places, one player may interact with a signal field associated with another player, simulating contact with this other player. Accordingly, using embodiments of the methods and systems described, a user can interact with a person or object represented by a signal field in a remote, virtual or simulated setup.

While this invention has been particularly shown and described with references to certain preferred embodiments thereof, it will be understood by those skilled in the art that various changes in form and details may be made therein without departing from the spirit and scope of the claims. Such variations are intended to be covered by the scope of this present application. As such, the foregoing description of embodiments of the present application is not intended to be limiting. Similarly, while embodiments of the present systems and methods is sometimes described with respect to particular settings (e.g., in a shopping or entertainment context), these are illustrative in nature and not intended to be limiting in any way.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

We claim:

1. A method for co-locating an Radio Frequency Identification (RFID) signal field with a representation perceptible by one or more human senses, the method comprising:
(a) accessing, by a user interface, a representation of a signal field stored in a memory element, the representation comprising a plurality of data points each recording a value of a characteristic of the signal field at a respective physical position;
(b) providing, by the user interface based on the accessed data points, a human-perceptible representation of the signal field to a user, the human-perceptible representation facilitating user interactions with the signal field using a RFID device;
(c) detecting, by an interactivity engine, an interaction between the RFID device and the signal field; and
(d) generating, by the interactivity engine, an action based on the detected interaction.

2. The method of claim 1, wherein step (a) comprises determining, by a probe, the value of a characteristic of the signal field at a respective physical position.

3. The method of claim 1, wherein step (b) comprises generating a two-dimensional or three-dimensional representation of the portion of the detected signal field.

4. The method of claim 1, wherein step (b) comprises generating a representation perceptible by one or more of: human sight, hearing, touch, smell, taste and sense of temperature.

5. The method of claim 1, wherein step (b) comprises generating a representation characterizing the signal field in one or more of the following aspects: field source, signal strength, operating frequency, RFID protocol, temporal movement and operational range.

6. The method of claim 1, wherein step (c) comprises detecting a movement of a portion of the RFID device towards or away from a portion of the signal field based on the human-perceptible representation of the signal field.

7. The method of claim 1, wherein step (d) comprises generating a human-perceptible output to the user based on the detected interaction.

8. The method of claim 1, wherein step (d) comprises modifying the signal field based on the detected interaction.

9. The method of claim 1, wherein step (d) comprises communicating a request to modify or update the representation of the signal field stored in the memory element based on the detected interaction.

10. The method of claim 1, wherein step (d) comprises communicating with the user interface to modify the human-perceptible representation of the signal field based on the detected interaction.

11. The method of claim 1, further comprising distinguishing the signal field from one or more other signal fields via the human-perceptible representation.

12. A system for co-locating an Radio Frequency Identification (RFID) signal field with a representation perceptible by one or more human senses, the system comprising:
a memory element storing a representation of a signal field, the representation comprising a plurality of data points each recording a value of a characteristic of the signal field at a respective physical position;
a user interface in electrical communication with the memory element, accessing the stored representation of the signal field, and providing a human-perceptible representation of the signal field to a user based on the accessed data points, the human-perceptible representation facilitating user interactions with the signal field using a RFID device; and
an interactivity engine detecting an interaction between the RFID device and the signal field, and generating an action based on the detected interaction.

13. The system of claim 12, further comprising a probe for determining a value of a characteristic of the signal field at a respective physical position.

14. The system of claim 12, wherein the user interface generates a two-dimensional or three-dimensional representation of the portion of the detected signal field.

15. The system of claim 12, wherein the user interface generates a representation perceptible by one or more of: human sight, hearing, touch, smell, taste and sense of temperature.

16. The system of claim 12, wherein the user interface generates a representation characterizing the signal field in one or more of the following aspects: field source, signal strength, operating frequency, RFID protocol, temporal movement and operational range.

17. The system of claim 12, wherein the interactivity engine detects a movement of a portion of the RFID device towards or away from a portion of the signal field.

18. The system of claim 12, wherein the interactivity engine generates a human-perceptible output to the user based on the detected interaction.

19. The system of claim 12, wherein the interactivity engine modifies the signal field based on the detected interaction.

20. The system of claim 12, wherein the interactivity engine communicates a request to modify or update the representation of the signal field stored in the memory element based on the detected interaction.
